(19) United States
(12) Patent Application Publication
(10) Pub. No.: US 2007/0166591 A1
(43) Pub. Date: Jul. 19, 2007

(54) POLYMER ELECTROLYTE COMPOSITION AND APPLICATION THEREOF

(75) Inventors: Yoichiro Machida, Tsukuba-shi (JP); Ryuma Kuroda, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/623,959

(22) Filed: Jan. 17, 2007

(30) Foreign Application Priority Data
Jan. 19, 2006 (JP) 2006-010824

(51) Int. Cl. H01M 8/10; H01M 10/40

(52) U.S. Cl. 429/33; 429/306; 429/314; 429/317

(57) ABSTRACT

To provide a polymer electrolyte membrane with excellent radical resistance, a polymer electrolyte composition for the polymer electrolyte membrane, and further a polymer electrolyte type fuel cell using the polymer electrolyte membrane. [1] A polymer electrolyte composition comprising the following component (a), (b) and (c): (a) a polymer electrolyte having a strong acid group, (b) a compound having at least one group containing a pentavalent phosphorous atom, and (c) an antioxidant
[2] The polymer electrolyte composition described in the above [1], wherein the component (b) comprises a copolymer expressed by the following formula (6): 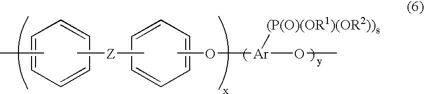
wherein Z represents a sulfonyl group or a carbonyl group. Ar represents a divalent aromatic group, R¹ and R² represent a hydrogen atom or a monovalent organic group. [3] A polymer electrolyte membrane obtained using the polymer electrolyte composition of the above [1] or [2]. [4] A fuel cell composed of the polymer electrolyte membrane described in the above [3].

### BACKGROUND OF THE INVENTION

1. Technical Field

The present invention relates to polymer electrolyte compositions, polymer electrolyte membranes using the polymer electrolyte compositions, above all, to a polymer electrolyte composition and polymer electrolyte membrane preferably used in fuel cells.

2. Description of the Related Art

In recent years, fuel cells draw attentions as a clean energy converting apparatus with high efficiency. In particular, polymer electrolyte type fuel cells using a polymer electrolyte membrane with proton conductivity have a compact structure and provide high power, they can be operated in a simple system, which draws attentions as a movable power source in vehicle applications and the like.

A polymer electrolyte type fuel cell can provide electromotive force in such manner: a polymer electrolyte having a sulfonic acid group, carboxylic acid group or the like in a polymer chain is processed into a membrane, membrane-electrode assembly with a pair of electrodes is provided on both surfaces of the membrane, fuel gas such as pure hydrogen and reformed hydrogen gas, or liquid fuel such as methanol and dimethyl ether is fed to one electrode (fuel electrode), oxygen gas or air as oxidant is fed to another electrode (air electrode).

Now, polymer electrolyte membranes used in polymer electrolyte type fuel cells have been studied actively on polymer electrolyte membranes of hydrocarbon based polymers (e.g. aromatic polymers and the like) from the viewpoint of heat resistance, mechanical strength or costs. As a problem associated with such hydrocarbon based polymers, it has been listed that long-term stability is low compared with the membrane of fluorine based polymer electrolytes conventionally used (for example, Nafion is listed, manufactured by DuPont Company). As factors for deteriorating the long-term stability, various reasons are assumed, one of which is known as that a polymer electrolyte membrane is deteriorated by peroxides (e.g. hydrogen peroxide and the like) generated in battery operation.

Namely, by cell reaction, in a catalyst layer formed in the interface between a polymer electrolyte membrane and an electrode, a peroxide, for example, hydrogen peroxide is generated in the foregoing air electrode by an incomplete reduction of proton, the thus generated peroxides become hydroxyl radicals while dispersing in a polymer electrolyte membrane, thereby it is thought that the polymer electrolyte membrane is deteriorated. Therefore, it is thought that a measure for polymer electrolyte type fuel cells to have long-term stability is to improve resistance of polymer electrolyte membranes against the radical (hereinafter called radical resistance), for example, the stability of a polymer electrolyte membrane in an oxidizing atmosphere using Fenton reagent and the like can be thought as an index thereof (see “Polymer material and technology pandect” edited by Polymer material and technology pandect editorial committee, pp. 518-520, published by Industrial Information Technology Service Center Corporation, on 7 Sep. 2004).

as a method imparting radical resistance to a polymer electrolyte membrane, Japanese Unexamined Patent Publication No. 2003-282096 discloses polymer electrolyte membrane for fuel cells with improved durability by a mixed composition that hindered phenols generally used as a radical scavenger and a trivalent organic phosphorous compound or a divalent organic sulfur compound used as a peroxide decomposer being blended with a polymer electrolyte (see “Polymer comprehensive dictionary” p. 413, supervisory translation by Itaru Mita, published by Maruzen Co. Ltd., on 20 Sep. 1994, on the above radical scavenger and peroxide decomposer).

Also, there is proposed a polymer electrolyte composition containing a specific polymer compound called aromatic polymeric phosphonic acids wherein a phosphonic acid group or the like directly bonds to an aromatic ring (for example, see Japanese Unexamined Patent Publication No. 2003-201403).

### SUMMARY OF THE INVENTION

But, the proton conductive membrane for fuel cell disclosed in Japanese Unexamined Patent Publication No. 2003-282096 was also not necessarily sufficient in the radical resistance under a strong oxidizing atmosphere.

Also, the polymer electrolyte membrane obtained from the polymer electrolyte composition disclosed in Japanese Unexamined Patent Publication No. 2003-201403 has excellent radical resistance, however, as exposure time in an oxidizing atmosphere (immersion in Fenton reagent) is lengthened, decreasing rate of weight becomes high, namely, there are instances that polymer electrolyte membranes are deteriorated. Thus, in the case where it is used in a polymer electrolyte type fuel cell requiring increasingly high stability as a polymer electrolyte membrane, there has been desired a polymer electrolyte membrane with radical resistance even when being exposed to a stronger oxidizing atmosphere.

An object of the present invention is to provide a polymer electrolyte composition capable of obtaining a polymer electrolyte membrane with excellent radical resistance, further, to provide a polymer electrolyte membrane obtained using the polymer electrolyte composition, and a polymer electrolyte type fuel cell obtained using the polymer electrolyte composition membrane.

The present inventors have keenly studied to improve radical resistance of separating membranes for fuel cells (polymer electrolyte membranes). As a result, to be surprised, they have found that a membrane obtained from a polymer electrolyte composition provided by mixing a compound having a group containing a pentavalent phosphorous atom and an antioxidant in a polymer electrolyte exhibits remarkably higher radical resistance than a membrane obtained from a composition provided by mixing each separately in a polymer electrolyte, together with further various studies, and thereby completed the present invention.

Namely, the present invention provides polymer electrolyte compositions described in the following [1] through [13].

[1] A polymer electrolyte composition comprising the following component (a), (b) and (c):

(a) a polymer electrolyte having a strong acid group,

(b) a compound having at least one group containing a pentavalent phosphorus atom, and

(c) an antioxidant.

[2] A polymer electrolyte composition described in the foregoing [1], wherein the weight ratio of the component (b) to the component (a) is 0.1 to 80% by weight.

[3] A polymer electrolyte composition described in the foregoing [1] or [2], wherein the weight ratio of the component (c) to the component (a) is 0.05 to 50.0% by weight.

[4] A polymer electrolyte composition described in any one of the foregoing [1] to [3], wherein the content of the component (b) is larger than the content of the component (c).

[5] A polymer electrolyte composition described in any one of the foregoing [1] to [4], wherein the component (b) comprises a compound shown in the following formula (1a) or a compound having a group shown in the formula (1b); 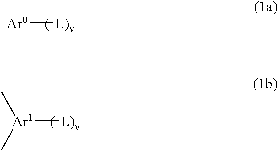
wherein Ar⁰ and Ar¹ represent an aromatic group, L represents a group shown in the following formula (2) or (3), v is an integer of 1 to 4, L may be different from each other when v is 2 or more, and L directly bonds to an aromatic ring of Ar⁰ or Ar¹: 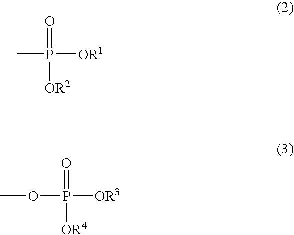
wherein R¹, R², R³ and R⁴ each independently represent a hydrogen atom or a monovalent organic group.

[6] A polymer electrolyte composition described in the foregoing [5], wherein the component (b) comprises a compound having a group shown in the foregoing formula (2).

[7] A polymer electrolyte composition described in the foregoing [5], wherein the component (b) comprises a polymer compound having a group shown in the foregoing formula (2) and/or a group shown in the foregoing formula (3).

[8] A polymer electrolyte composition described in the foregoing [7], wherein the polymer compound comprises a polymer compound having a structural unit expressed by the following formula (4): 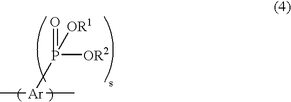
wherein Ar represents an aromatic group having carbon atoms of 4-18, the aromatic group may having a substituent group, s is an average number per one of the structural unit of the group expressed by the foregoing formula (2) being bonded to Ar, and represents a positive number of 8 or less, R¹ and R² are the same definitions as described above.

[9] A polymer electrolyte composition described in the foregoing [7], wherein the polymer compound comprises a polymer compound having a structural unit expressed by the following formula (5): 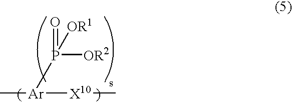
wherein X¹⁰ represents a direct bond, an oxygen atom or a sulfur atom, Ar, s, R¹ and R² are the same definitions as described above.

[10] A polymer electrolyte composition described in the foregoing [7], wherein the polymer compound comprises a copolymer expressed by the following formula (6): 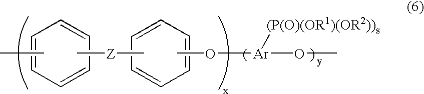
wherein Z represents a sulfonyl group or a carbonyl group, x and y are mole ratios of each structural unit in the copolymer, each representing 0.01 to 0.99, the sum of x and y is 1, Ar, s, R¹ and R² are the same definitions as described above.

[11] A polymer electrolyte composition described in any one of the foregoing [1] to [10], wherein the component (c) is a hindered phenol type compound.

[12] A polymer electrolyte composition described in any one of the foregoing [1] to [11], wherein the component (a) is a block copolymer comprising a block having a strong acid group and a block essentially having no acid group.

[13] A polymer electrolyte composition comprising the following component (d) and (c):

(d) a polymer electrolyte having at least one group containing a pentavalent phosphorous atom and a strong acid group, and

(c) an antioxidant.

Further, the present invention provides;

[14] A polymer electrolyte membrane obtained using the polymer electrolyte composition described in any one of the foregoing [1] to [13].

[15] A polymer electrolyte type fuel cell obtained using the polymer electrolyte membrane described in the foregoing [14].

A polymer electrolyte membrane obtained from the polymer electrolyte composition of the present invention is excellent in radical resistance compared with the conventional polymer electrolyte membranes, by using the membrane as a polymer electrolyte membrane for fuel cell, a polymer electrolyte type fuel cell with excellent durability and long-term stability can be obtained.

### DETAILED DESCRIPTION OF THE INVENTION

Preferable embodiments of the present invention will be further explained in detail below.

Component (b)

The component (b) of the polymer electrolyte composition of the present invention is a compound which has at least one group containing a pentavalent phosphorous atom. Herein, the group containing a pentavalent phosphorous atom expresses any of phosphoric acid group, phosphoric monoester group, phosphoric diester group, phosphonic acid group, phosphonic monoester group, and phosphonic diester group.

Also, a residue to which these groups are bonded may be an aliphatic hydrocarbon group or an aromatic hydrocarbon group, or may be a group containing both aliphatic hydrocarbon group and aromatic hydrocarbon group. The aliphatic hydrocarbon group may be linear or cyclic.

A production method of compound having these groups is not particularly limited, and can employ known methods. For example, as a production method of an aliphatic hydrocarbon compound having a phosphoric acid or phosphoric ester group, there are listed a method that aliphatic alcohol is reacted with phosphorous oxychloride (POCl₃) to convert into phosphoric ester, a method that in reacting aliphatic alcohol with phosphorous oxychloride (POCl₃), partly leaving an unreacted P(O)—Cl group, which is hydrolyzed to convert to P(O)—OH group, thereby to give an aliphatic compound having a phosphoric acid group or phosphoric monoester group, and the like. Also, aliphatic compounds having a phosphoric acid group or phosphoric monoester group are ordinarily commercially available for applications in color protection agent of resin or fiber, plasticizer of vinyl acetate polymer and the like, and these can be also used. Also, as an example of synthesis of aliphatic hydrocarbon compound having a phosphoric acid group or phosphoric ester group, there are listed a method that an aliphatic halide is reacted with trialkyl phosphite or dialkyl phosphite to give an aliphatic compound having a phosphonic ester group, a method that the aliphatic compound having a phosphonic ester group is hydrolyzed to give an aliphatic compound having a phosphonic acid group, a method that an aliphatic compound having a carboanion, an amine group or a mercapto group is introduced with a phosphoric acid group by Mannich reaction using formaldehyde and phosphorous acid, and the like.

As the component (b) in the polymer electrolyte composition of the present invention, an aromatic compound wherein a group containing a pentavalent phosphorous atom directly bonds to an aromatic ring is preferable, and a compound shown in the following formula (1a) or a compound having a group shown in the formula (1b) is listed; 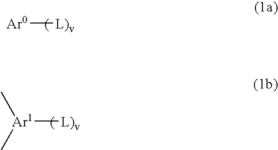
wherein Ar⁰ represents an aromatic group and Ar¹ represents an aromatic group, L represents a group shown in the following formula (2) or (3), v is an integer of 1 to 4, L may be different from each other when v is 2 or more, and L directly bonds to an aromatic ring of Ar⁰ or Ar₁: 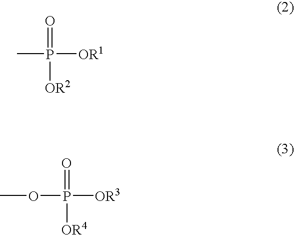
wherein R¹, R², R³ and R⁴ each independently represent a hydrogen atom or a monovalent organic group.

Here, Ar⁰ or Ar¹ includes aromatic rings such as benzene ring, naphthalene ring and anthracene ring; aromatic heterocyclic rings such as pyridine ring, furan ring, pyrrole ring and pyrimidine ring; aromatic rings having substituents on these rings (e.g. an alkyl group having carbon atoms of about 1-4, an alkenyl group having carbon atoms of about 2-4, an alkynyl group having carbon atoms of about 2-4, an alkoxy group having carbon atoms of about 1-4, hydroxyl group and thiol group); or groups having aromatic heterocycles.

Additionally, in the group shown in the formula (1b), v of L directly bonds to an aromatic ring of Ar¹, and Ar¹ is a group having two bonds other than L.

Here, when R¹ and R² in the formula (2), R³ and R⁴ in the formula (3) are a monovalent organic group, as a typical example of the organic group, there are listed alkyl groups having carbon atoms of 1 to 22 such as methyl group, ethyl group, n-propyl group, isopropyl group, n-butyl group, isobutyl group, sec-butyl group, t-butyl group, t-pentyl group, isooctyl group, t-octyl group, 2-ethylhexyl group, cyclopentyl group, cyclohexyl group, cycloheptyl group, cyclooctyl group, 1-methylcyclopentyl group, 1-methycyclohexyl group, 1-methyl-4-isopropylcyclohexyl group, nonyl group, decyl group, undecyl group, dodecyl group, tridecyl group, tetradecyl group, pentadecyl group, hexadecyl group, heptadecyl group, octadecyl group, nonadecyl group and icosyl group; and groups having aromatic rings such as phenyl group, toluyl group, naphthalene group and benzyl group, but it is not limited thereto. As a production method of these compounds, there are listed a method that a compound having a phenolic hydroxide group is reacted with phosphorous oxychloride to introduce a phosphoric ester group or phosphoric acid group, a method that a halogen group bonded to an aromatic ring is reacted with trialkyl phosphite, and if necessary, hydrolyzed to introduce a phosphonic ester group or phosphonic acid group, and the like, in the same manner as the method for introducing these groups into aliphatic hydrocarbons as described above.

In this way, when a compound shown in the foregoing formula (1a) or a compound having a group shown in the formula (1b) is used as the component (b), it is preferable because a polymer electrolyte membrane with remarkably excellent radical resistance can be obtained.

The component (b) of the present invention can employ the compound described above, but a relatively stable group shown in the foregoing formula (2) as a group containing a pentavelent phosphorous atom being produced easily, namely, a phosphonic acid group or a phosphonic ester group capable of becoming a phosphonic acid group is preferred.

Also, when the component (b) of the present invention is mixed with the foregoing component (a) to form a membrane, a polymer compound is preferable from the viewpoint that bleeding hardly occurs. Specifically, there are listed resins having the above phosphoric groups and/or the above phosphonic groups in a molecule such as polyethylene resin, polypropylene resin, polytetrafluoroethylene resin, polyethersulfone resin, polyetheretherketone resin, polyetheretherketone resin, linear phenol-formaldehyde condensation resin, polystyrene resin, poly(trifluorostyrene) resin, polyphenylene resin, poly(2,3-diphenyl-1,4-phenyleneoxide) resin, poly(aryletherketone) resin, poly(arylethersulfone) resin, poly(phenylquinoxaline) resin, poly(benzylsilane) resin, styrene-ethylene-tetrafluoroethylene copolymer, polystyrene-poly(vinylidene fluoride) copolymer, and polystyrene-tetrafluoroethylene copolymer, among them, aromatic resins are preferable such as polyethersulfone resin, polyetheretherketone resin, polyetheretherketone resin, polyphenylene resin, poly(2,3-diphenyl-1,4-phenyleneoxide) resin, poly(aryletherketone) resin, poly(arylethersulfone) resin, poly(phenylquinoxaline) resin and poly(benzylsilane) resin. Further, a polymer compound having a phosphoric group and/or phosphonic group of the present invention may be a resin randomly copolymerized, an alternating copolymer, a graft copolymer or a block copolymer having a structural unit of the compound described above. These can be produced in combinations of known methods. Also, though the degree of polymerization of the polymer compound is not particularly limited, ordinarily, it is about 10 to 10⁴, as the molecular weight, ordinarily about 10³ to 10⁶. When the degree of polymerization is 10 or more, as the mechanical strength tends to increase, it is preferable because of better membrane formation, and when it is 10⁴ or less, as the solubility to solvents tends to increase, it is also preferable because formability of casting film and moldability become good.

In particular, as the component (b) of the present invention as described above, a phosphonic acid group or a phosphonic ester group capable of becoming phosphonic acid group is advantageous as a group having a pentavalent phosphorous atom, further, when these groups have a structure wherein they bond directly to an aromatic ring, radical resistance is preferably more improved. From these viewpoints, a polymer compound having a structural unit shown in the following formula (4) is preferable as the component (b) of the present invention. 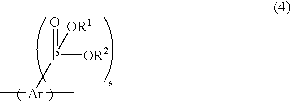
wherein Ar represents an aromatic group having carbon atoms of 4-18, the aromatic group may have a substituent group, s is an average number per one of the structural unit including Ar, and represents a positive number of 8 or less, R¹ and R² represent a hydrogen atom or an alkyl group.

Also, a polymer compound having a structural unit shown in the following formula (5) is further preferable as the component (b) of the present invention: 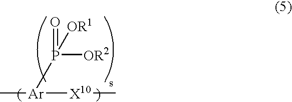
wherein X¹⁰ represents a direct bond, an oxygen atom or a sulfur atom, Ar, s, R¹ and R² are the same definitions as described above.

In this way, one that a divalent aromatic group Ar forming a polymer chain is bonded by a direct bond, an ether bond or a sulfide bond can easily produced by a known polycondensation.

Above all, as the component (b), a polymer compound having a phosphonic acid group or a phosphonic ester group shown in the following formula (6) is preferable, the polymer compound can be obtained by the method described in the foregoing Japanese Unexamined Patent Publication No. 2003-282096: 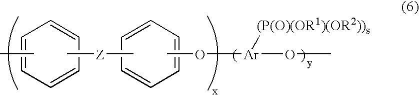
wherein Z represents a sulfonyl group or a carbonyl group, x and y are mole ratios of each structural unit in the copolymer, each representing 0.01 to 0.99, the sum of x and y is 1, Ar, s, R¹ and R² are the same definitions as described above. When the component (b) is a polymer compound expressed by the foregoing formula (6), it is preferable from the viewpoint of improving radical resistance in polymer electrolyte. Also, in R₁ and R₇, one of which is preferably a hydrogen atom, and it is more preferable when both of which are a hydrogen atom.

Here, as typical examples of Ar in the above formulas (4), (5) and (6), there can be listed divalent aromatic groups of hydrocarbon such as 1,2-phenylene group, 1,3-phenylene group, 1,4-phenylene group, naphthalene-1,4-diyl group, naphthalene-1,5-diyl group, naphthalene-2,6-diyl group, naphthalene-2,7-diyl group, naphthalene-2,3-diyl group, biphenyl-4,4′-diyl group, biphenyl-3,3′-diyl group, p-terphenyl-4,4″-diyl group, 2,2-diphenylpropane-4′,4″-diyl group, fluorene-2,7-diyl group and fluorene-3,6-diyl group; and divalent aromatic groups containing a heteroatom such as carbazole-2,7-diyl group, carbazole-3,6-diyl group, thiophene-2,5-diyl group, dibenzothiophene-2,7-diyl group, furan-2,5-diyl group, dibenzofuran-2,7-diyl group, dibenzofuran-3,6-diyl group, diphenylamine-4,4′-diyl group and diphenylether-4,4′-diyl group.

Also, these aromatic groups may having a substituent group, and as such substituent group, for example, there are listed a linear or branched alkyl group that may be substituted with a hydroxyl group or a halogen atom such as methyl group, ethyl group, 2-propyl group, t-butyl group, hydroxymethyl group and trifluoromethyl group; a linear or branched alkoxy group that may be substituted with a halogen atom such as methoxy group, ethoxy group and trifluoromethoxy group; a phenyl group that may be substituted with an alkyl group, alkoxy group, phenyl group, phenoxy group, halogen atom or sulfonic acid group such as phenyl group, methylphenyl group, methoxyphenyl group, biphenyl group, phenoxyphenyl group, chlorophenyl group and sulfophenyl group; and a phenoxy group that may be substituted with an alkyl group, alkoxy group or sulfonic acid group such as phenoxy group, methylphenoxy group, methoxyphenoxy group, and sulfophenoxy group;

an alkyloxycarbonyl group such as ethoxycarbonyl group; an alkylcarabonyloxy group such as ethylcarbonyloxy group; an aminocarboxyl group or N-alkylaminocarboxyl group; an aminocarbonyl group or N-alkylaminocarbonyl group; an amino group, an amino group such as dimethylamino group whose nitrogen atom may be substituted with an alkyl group; a halogen atom such as fluorine atom, chlorine atom, bromine atom and iodine atom; a ureide group; an acylamino group; a carboxyl group; a hydroxyl group; a cyano group; a sulfonic acid group; and an aminosulfonyl group.

In particular, as preferable examples of Ar in the present invention, for example, there are listed phenylene groups that may be substituted such as 1,2-phenylene group, 1,3-phenylene group, 1,4-phenylene group, 3-methyl-1,2-phenylene group, 3-ethyl-1,2-phenylene group, 3-metoxy-1,2-phenylene group, 3-ethoxy-1,2-phenylene group, 3-bromo-1,2-phenylene group 3-chloro-1,2-phenylene group, 3,6-dimethyl-1,2-phenylene group, 4,5-dibromo-1,2-phenylene group, 2-methyl-1,3-phenylene group, 2-ethyl-1,3-phenylene group, 2-methoxy-1,3-phenylene group, 2-ethoxy-1,3-phenylene group, 2-bromo-1,3-phenylene group, 2-chloro-1,3-phenylene group, 5-methyl-1,3-phenylene group, 5-bromo-1,3-phenylene group, 2-methyl-1,4-phenylene group, 2-ethyl-1,4-phenylene group, 2-methoxy-1,4-phenylene group, 2-ethoxy-1,4-phenylene group, 2-bromo-1,4-phenylene group, 2-chloro-1,4-phenylene group, 2,6-dimethyl-1,4-phenylene group, 2,6-dibromo-1,4-phenylene group, 2-phenyl-1,4-phenylene group and 2,3-diphenyl-1,4-phenylene group;

biphenyldiyl groups that may be substituted such as biphenyl-4,4′-diyl group, biphenyl-3,3′-diyl group, 3,3′-diphenylbiphenyl-4,4′-diyl group, 3,3′-bisphenoxybiphenyl-4,4′-diyl group, 3,3′-dichlorobiphenyl-4,4′-diyl group, 3,3′-dibromobiphenyl-4,4′-diyl group, 2,2′-dichlorobiphenyl-3,3′-diyl group, 2,2′-dibromobiphenyl-3,3′-diyl group, 4,4′-dichlorobiphenyl-3,3′-diyl group and 4,4′-dibromobiphenyl-3,3′-diyl group; and carbazolediyl groups that may be substituted such as carbazole-2,2′-diyl group, carbazole-3,3′-diyl group, N-ethylcarbazole-2,2′-diyl group and N-ethylcarbazole-3,3′-diyl group.

Among them, preferable Ar is a phenylene group that may be substituted or a biphenyldiyl group that may be substituted, in particular, 1,3-phenylene group, 1,4-phenylene group, biphenyl-4,4′-diyl group and biphenyl-3,3′-diyl group are preferred.

In the general formula (6), x and y represent mole ratios of each structure unit in the copolymer, each representing 0.01 to 0.99, the sum of x and y is 1, preferably y is 0.1 to 0.9. These mole ratios can be adjusted by loading ratio of monomers to derive the foregoing structural units.

In the copolymer having a phosphonic group expressed by the general formula (6), when R¹ and/or R² are a hydrogen atom, it may be salt or partially converted salt. In this case, as a cation, alkali metal ion and alkali earth metal ion are listed, and lithium, sodium and potassium are particularly preferable.

Component (c)

As an antioxidant used as the component (c) of polymer electrolyte composition in the present invention, there may be used a phenol based compound and amine based compound listed as a radical scavenger in “Polymer comprehensive dictionary” p. 413, supervisory translation by Itaru Mita, published by Maruzen Co. Ltd., on 20 Sep. 1994 or an organic phosphorous based compound and organic sulfur compound listed as a peroxide decomposer in “Polymer comprehensive dictionary” p. 413, supervisory translation by Itaru Mita, published by Maruzen Co. Ltd., on 20 Sep. 1994, or a mixture thereof.

Here, a radical scavenger deactivates radicals by giving hydrogen from a phenol group of phenol based compound or an amino group of amine based compound to radicals, which in turn becomes a compound containing phenoxy radical or amine radical to stabilize itself, particularly among phenoxy compounds, a compound with a branched hydrocarbon group having carbon atoms of 3 or more at an ortho position to a phenolic hydroxyl group is called a hindered phenol type compound, which is preferable because of fast reaction rate of hydrogen donating reaction to radicals. A peroxide decomposer is a compound containing a trivalent phosphorous atom or a divalent sulfur atom, which is oxidized by radicals into a compound containing a pentavalent phosphorous atom or, a tetravalent sulfur atom or a hexavalent sulfur atom to eliminate radicals.

As the specific examples of the above hindered phenol type compound, there are listed 1,3,5-trimethyl-2,4,6-tris(3,5-di-t-butyl-4-hydroxybenzyl)benzene, 1,3,5-(4-t-butyl-3-hydroxy-2,6-dimethylbenzyl)isocyanuric acid, penthaerythrityl-tetrakis[3-(3,5-di-t-butyl-4-hydroxyphenyl)propionate], 2,6-di-butyl-4-methylphenol, 2-t-butyl-6-(3-t-butyl-2-hydroxy-5-methylbenzyl)-4-methylphenyl acrylate, 2-[1-(2-hydroxy-3,5-di-t-pentylphenyl)ethyl-4,6-di-t-pentylphenyl acrylate, octadecyl-3-(3,5-di-t-butyl-4-hydroxyphenyl)propionate, 1,1,3-tris(2-methyl-4-hydroxy-5-t-butylphenyl)butane, triethyleneglycolbis[3-(3-t-butyl-5-methyl-4-hydroxyphenyl)propionate, 2,4-bis(n-octylthio)-6-(4-hydroxy-3,5-di-t-butylanilino)-1,3,5-triazine, N,N′-hexamethylenebis(3,5-di-t-butyl-4-hydroxy-hydrocinnamide), 1,6-hexanediol-bis[3-(3,5-di-t-butyl-4-hydroxyphenyl)propionate], 2,2-thio-diethylenebis[3-(3,5-di-butyl-4-hydroxyphenyl)propionate], 3,9-bis[2,[3-(3-t-butyl-4-hydroxy-5-methylphenyl)propionyloxy]1,1-dimethylethyl]-2,4,8,10-tetraoxaspiro[5,5]undecane, tris(3,5-t-butyl-di-4-hydroxybenzyl)isocyanurate, isooctyl-3-(3,5-di-t-butyl-hydroxypheny)propionate, 4,4′-thiobis(6-t-butyl-3-methylphenol), and 6-(3-(3-t-butyl-4-hydroxy-5-methylphenyl)propoxy]-2,4,8,10-tetra-t-butylbenz[d,f][1,3,2]dioxaphosphepin, and the like.

As the specific examples of the above amine based compound, there are listed p,p′-dioctyldiphenylamine, phenyl-α-naphthyl dimethyl succinate-1-(2-hydroxyethyl)-4-hydroxy-2,2,6,6-tetramethylpiperidine polycondensate, poly[[6-(1,1,3,3-tetramethylbutyl)amino-1,3,5-triazine-2,4-diyl][(2,2,6,6-tetramethyl-4-piperidyl)imino]hexamethylene[(2,2,6,6-tetramethyl-4-piperidyl)imino]], N,N′-bis(3-aminopropyl)ethylenediamine-2,4-bis[N-butyl-N-(1,2,2,6,6-pentamethyl-4-piperidyl)amino]-6-chloro-1,3,5-triazine polycondensate, bis(1-octyloxy-2,2,6,6-tetramethyl-4-piperidyl)sebacate, bis(2,2,6,6-tetramethyl-4-piperidyl)sebacate, 2-(3,5-di-t-butyl-4-hydroxybenzyl)-2-n-butyl bis(1,2,2,6,6-pentamethyl-4-piperidyl)malonate, bis(1,2,2,6,6-pentamethyl-4-piperidyl)sebacate, tetrakis(1,2,2,6,6-pentamethyl-4-piperidyl)-1,2,3,4-butanetetracarboxylate, tetrakis(2,2,6,6-tetramethyl-4-piperidyl)-1,2,3,4-butanetetracarboxylate, a mixed ester compound of 1,2,3,4-butanetetracarboxylic acid with 1,2,2,6,6-pentamethyl-4-piperidinol and 1-tridecanol, a mixed ester compound of 1,2,3,4-butanetetracarboxylic acid with 2,2,6,6-tetramethyl-4-piperidinol and 1-tridecanol, a mixed ester compound of 1,2,3,4-butanetetraoarboxylic acid with 1,2,2,6,6-pentamethyl-4-piperidinol and 3,9-bis(2-hydroxy-1,1-dimethylethyl)-2,4,8,10-tetraoxaspiro[5,5]undecane, a mixed ester compound of 1,2,3,4-butanetetracarboxylic acid with 2,2,6,6-tetramethyl-4-piperidinol and 3,9-bis(2-hydroxy-1,1-dimethylethyl)-2,4,8,10-tetraoxaspiro[5,5]undecane, (2,2,6,6-tetramethylene-4-piperidyl)-2-propylene carboxylate, and (1,2,2,6,6-pentamethyl-4-piperidyl)-2-propylene carboxylate, and the like.

As the specific examples of the above organic phosphorous based compound, there are listed trivalent phosphorus compounds such as bis(2,6-di-t-butyl-4-methylpheny)pentaerythritoldiphosphite, bis[2,4-di(1-phenylisopropyl)phenyl]pentaerythritoldiphosphite, trilauryltrithiophosphite, tris(2,4-di-t-butylphenyl)phosphite, distearyl pentaerythritoldiphosphite, tetrakis(2,4-di-t-butylphenyloxy)-4,4′-biphenylene-di-phosphine, 2-[[2,4,8,10-tetrakis(1,1-dimethylethyl)dibenzo[d,f][1,3,2]dioxaphosphepin-6-yl]oxy]-N,N-bis[2-[2,4,8,10-tetrakis(1,1-dimethylethyl)dibenzo[d,f][1,3,2]dioxaphosphepin-6-yl]oxy]-ethyl]etanamine, and 2,2′-methylenebis(4,6-di-t-butylphenyl)octylphosphite, and the like.

As the specific examples of the above sulfur based compound, there are listed dilauryl-3,3′-thiodipropionate, dimyristyl-3,3′-thiodipropionate, distearyl-3,3′-thiodipropionate, and pentaerythritol-tetrakis(3-laurylthiopropionate) and the like.

As the above antioxidant, commercially available antioxidants as additives for resins such as polyethylene and polypropylene may be used, for example, there are listed IRGANOX, IRGAFOS manufactured by Chiba Specialty Chemicals Corporation, Sumilizer manufactured by Sumitomo Chemical Co. Ltd., Cyanox manufactured by Cytex Industries Inc., and Adekastab manufactured by Asahi Denka Co. Ltd. These may be used after purification as necessary, but ordinarily, they may be used as they are since pure-grade commercial products can be readily obtained from the market. Also, purity of antioxidant contained in a commercial product can be measured by known methods such as GC and HPLC to determine the loading amount of the component (c) in the polymer electrolyte composition of the present invention.

The above antioxidants can be used in one kind or, in two kinds or more concomitantly as the component (c) of the present invention, and it is particularly preferable to be selected from hindered phenol type compounds. It is preferable to use the hindered phenol type compound as the component (c) from the viewpoint of enhancement of radical resistance in polymer electrolyte.

Component (a)

Next, the component (a) of polymer electrolyte having a strong acid group in the polymer electrolyte composition of the present invention will be explained.

As the polymer electrolyte having a strong acid group in the present invention, there is listed an electrolyte which has a strong acid group in main chain, in side chain or at the ends of a polymer. As the strong acid group, there are listed a sulfonic acid group (—SO₃H), a sulfonamide group (—SO₂—NH₂), a sulfonylimide group (—SO₂—NH—SO₂—), a sulfuric group (—OSO₃H), a fluoroalkylenesulfonic acid group (e.g. —CF₂SO₃H can be listed) and a group shown by the following formula (7), and a sulfonic acid group is particularly preferable. The proton conductivity of the polymer electrolyte is ordinarily 1×10⁻⁴ S/cm or more, preferably about 1×10⁻³ to 1 S/cm: 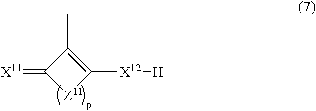
wherein X¹¹ and X¹² each independently represent an oxygen atom, a sulfur atom, or —NQ¹-, Z¹¹ represents a carbonyl group, a thiocarbonyl group, —C(NQ²)-, an alkylene group that may have a substituent, or an arylene group that may have a substituent, also, Q¹ and Q² represent a hydrogen atom, an alkyl group having carbon atoms of 1-6 that may have a substituent, or an aryl group having carbon atoms of 6-10 that may have a substituent, p represents a repeating number of an integer of 0 to 10, and additionally, Z¹¹ of p may be the same or different from each other.

As a typical example of such polymer electrolyte, there are exemplified; (A) a polymer electrolyte that a strong acid group is introduced to a polymer having main chain composed of aliphatic hydrocarbon; (B) a polymer electrolyte that a strong acid group is introduced to a polymer having a main chain composed of aliphatic hydrocarbon where part of hydrogen atoms are substituted with fluorine; (C) a polymer electrolyte that a strong acid group is introduced to a polymer having main chain containing an aromatic ring; (D) a polymer electrolyte that a strong acid group is introduced to a polymer essentially free of carbon atom such as polysiloxane and polyphosphazene; and (E) a polymer electrolyte that a strong acid group is introduced to a copolymer composed of 2 or more kinds selected from the repeating units composing a polymer of (A) to (D) before introducing a strong acid group. Of the above examples, a sulfonic acid group is preferable as a strong acid group.

An example of the above polymer electrolytes of (A) to (E) is represented by the polymer having a sulfonic acid group as a preferable strong acid group.

As polymer electrolytes of the above (A), for example, there are listed polyvinylsulfonic acid, polystyrenesulfonic acid and poly(α-methylstyrene)sulfonic acid and the like.

Also, as polymer electrolytes of the above (B), there are listed sulfonic acid type polystyrene-(graft)-ethylene-tetrafluoroethylene copolymer composed of a main chain which is formed by copolymerization of fluorocarbon based vinyl monomer with hydrocarbon based vinyl monomer and of a hydrocarbon type side chain having a sulfonic acid group (ETFE, e.g. Japanese Unexamined Patent Publication No. Hei 9-102322 (1997)), and sulfonic acid type poly(trifluorostyrene)-(graft)-polytrifluoroethylene membrane that a membrane produced by copolymerization of fluorocarbon based vinyl monomer with hydrocarbon based vinyl monomer is graft-polymerized with α,β,β-trifluorostyrene, a sulfonic acid group is introduced thereto to give a polymer electrolyte membrane (e.g. U.S. Pat. Nos. 4,012,303 and 4,605,685).

As the polymer electrolyte of the above (C), it may contain a heteroatom like an oxygen atom in main chain, for example, there are listed electrolytes that a sulfonic acid group is introduced to each of homopolymers such as polyetheretherketone, polysulfone, polyethersulfone, poly(arylene ether), polyimide, poly((4-phenoxybenzoyl)-1,4-phenylene), polyphenylenesulfide and polyphenylquinoxaline; sulfoarylated polybenzimidazole and sulfoalkylated polybenzimidazole, and the like.

Also, as polymer electrolytes of the above (D), for example, a resin wherein a sulfonic acid group is introduced to polyphosphazene is listed.

As polymer electrolytes of the above (E), there are listed electrolytes that a sulfonic acid group may be introduced to a random copolymer, to an alternating copolymer or to a block copolymer. As an example that a sulfonic acid group is introduced to a random copolymer, there is listed sulfonated polyethersulfone-dihydroxybipheneyl co-condensate (e.g. Japanese Unexamined Patent Publication No. Hei 11-116679 (1999)).

Above all, as the component (a) of the present invention, a polymer electrolyte exemplified in the above (C) wherein a sulfonic acid group is introduced to a polymer having an aromatic ring in main chain is preferable, and specifically, preferable is a polymer electrolyte which has a structural unit shown in the following formula (8) and the above sulfonic acid group in at least part of the structural unit: 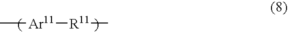
wherein Ar¹¹ represents a divalent aromatic group that may be substituted by an alkyl group having carbon atoms of 1-10, an alkoxy group having carbon atoms of 1-10, an aryl group having carbon atoms of 6-10 or an aryloxy group having carbon atoms of 6-10, R¹¹ represents a direct bond, an oxy group, a sulfide group, a carbonyl group, a sulfinyl group or a sulfonyl group.

Here, as the group expressed by Ar¹¹ in the foregoing formula (8), for example, there are listed a divalent monocyclic aromatic hydrocarbon group such as 1,3-phenylene and 1,4-phenylene; a divalent condensation type aromatic hydrocarbon group such as 1,3-naphthalenediyl, 1,4-naphthalenediyl, 1,5-naphthalenediyl, 1,6-naphthalenediyl, 1,7-naphthalenediyl, 2,6-naphthalenediyl and 2,7-naphthalenediyl; a divalent polycyclic aromatic hydrocarbon group such as 3,3′-biphenylene, 3,4′-biphenylene, 4,4′-biphenylene, diphenylmethane-4′,4′-diyl, 2,2-diphenylpropane-4′,4″-diyl and 1,1,1,3,3,3-hexafluoro-2,2-diphenylpropane-4′,4″-diyl; and a heterocyclic aromatic hydrocarbon group such as pyridinediyl, quinoxalinediyl and thiophenediyl. Among them, a divalent aromatic hydrocarbon group is preferable.

Also, as described above, these groups may be substituted with an alkyl group having carbon atoms of 1-10, an alkoxy group having carbon atoms of 1-10, an aryl group having carbon atoms of 6-10 or an aryloxy group having carbon atoms of 6-10. Herein, as an alkyl group having carbon atoms of 1-10, for example, there are listed an alkyl group having carbon atoms of 1-10 such as methyl group, ethyl group, n-propyl group, isopropyl group, allyl group, n-butyl group, sec-butyl group, tert-butyl group, isobutyl group, n-pentyl group, 2,2-dimethylpropyl group, cyclopentyl group, n-hexyl group, cyclohexyl group, 2-methylpentyl group, 2-ethylpentyl group; and these alkyl groups substituted with a halogen atom such as fluorine atom, chlorine atom and bromine atom, hydroxyl group, nitrile group, amino group, methoxy group, ethoxy group, isopropyloxy group, phenyl group and phenoxy group, having the total carbon atoms of 1 to 10 including a substituent group.

As an alkoxy group having carbon atoms of 1-10, for example, there are listed an alkoxy group having carbon atoms of 1-10 such as methoxy group, ethoxy group, n-propyloxy group, isopropyloxy group, n-butyloxy group, sec-butyloxy group, tert-butyloxy group, isobutyloxy group, n-pentyloxy group, 2,2-dimethylpropyloxy group, cyclopentyloxy group, n-hexyloxy group, cyclohexyloxy group, 2-methylpentyloxy group and 2-ethylhexyloxy group; and these alkoxy groups substituted with a halogen atom such as fluorine atom, chlorine atom and bromine atom, hydroxyl group, nitrile group, amino group, methoxy group, ethoxy group, isopropyloxy group, phenyl group and phenoxy group, having the total carbon atoms of 1 to 10 including a substituent group.

As an aryl group having carbon atoms of 6-10, for example, there are listed an aryl group having carbon atoms of 6-10 such as phenyl group and naphthyl group; and these aryl groups substituted with a halogen atom such as fluorine atom, chlorine atom and bromine atom, hydroxyl group, nitrile group, amino group, methoxy group, ethoxy group, isopropyloxy group, phenyl group and phenoxy group, having the total carbon atoms of 6 to 10 including a substituent group.

Also, an aryloxy group having carbon atoms of 6-10, for example, there are listed an aryloxy group having carbon atoms of 6-10 such as phenoxy group and naphtyloxy group and these aryloxy groups substituted with a halogen atom such as fluorine atom, chlorine atom and bromine atom, hydroxyl group, nitrile group, amino group, methoxy group, ethoxy group, isopropyloxy group, phenyl group and phenoxy group, having the total carbon atoms of 6 to 10 including a substituent group.

Example of the structural unit shown in the foregoing formula (8) with a sulfonic acid group are the following 10-1 through 10-16. Among them, from the view point where a polymer electrolyte having an excellent mechanical strength can be obtained, the structural unit of 10-1, 10-9 or 10-13 is preferable.

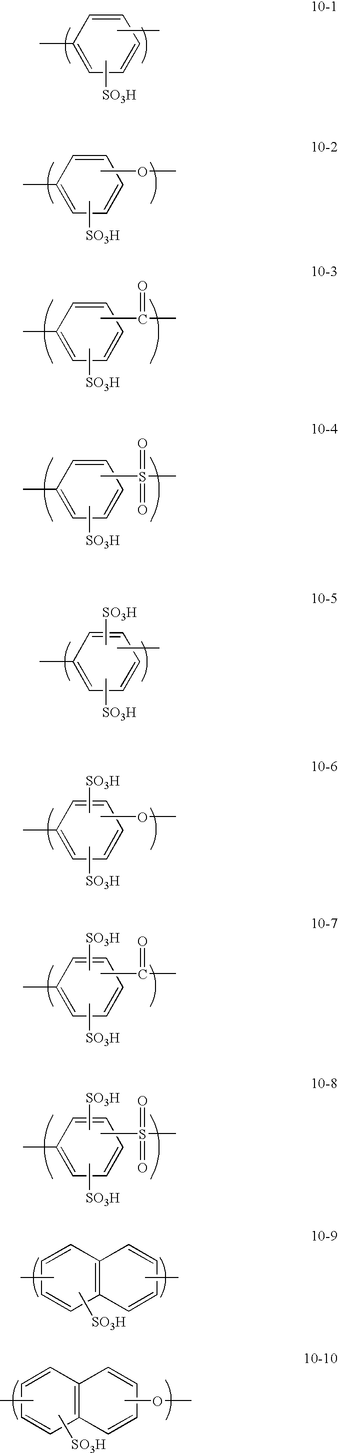

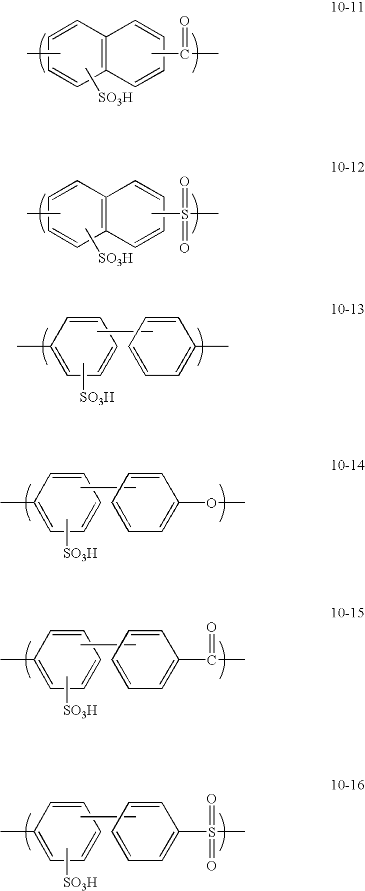

Also, as the component (a) of the present invention, preferable is a polymer electrolyte which has a structural unit expressed by the following formula (8a), (8b) or (8c) and a sulfonic acid group in the structural unit: 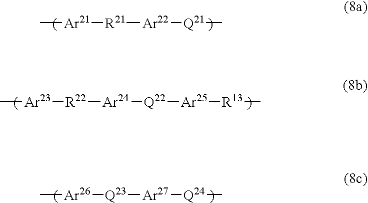
wherein Ar²¹, Ar²², Ar²³, Ar²⁴. Ar²⁵, Ar²⁶ and Ar²⁷ (hereinafter, expressed as “Ar²¹-Ar²⁷”) each independently represent a divalent aromatic group that may have an alkyl group having carbon atoms of 1-10, an alkoxy group having carbon atoms of 1-10, an aryl group having carbon atoms of 6-10 or an aryloxy group having carbon atoms of 6-10, Q²¹ TO Q²⁴ each independently represent an oxy group or a sulfide group, R²¹, R²² and R¹³ each independently represent a carbonyl group or a sulfonyl group

Here, in the above formulas (8a), (8b) and (8c), as the groups expressed by Ar²¹-Ar²⁷, the same groups as the above Ar¹¹ can be exemplified.

Here, as the structural unit expressed by the foregoing formulas (8a) with a sulfonic acid group, for example, structural units expressed by the following formulas 11-1 through 11-7 can be exemplified.

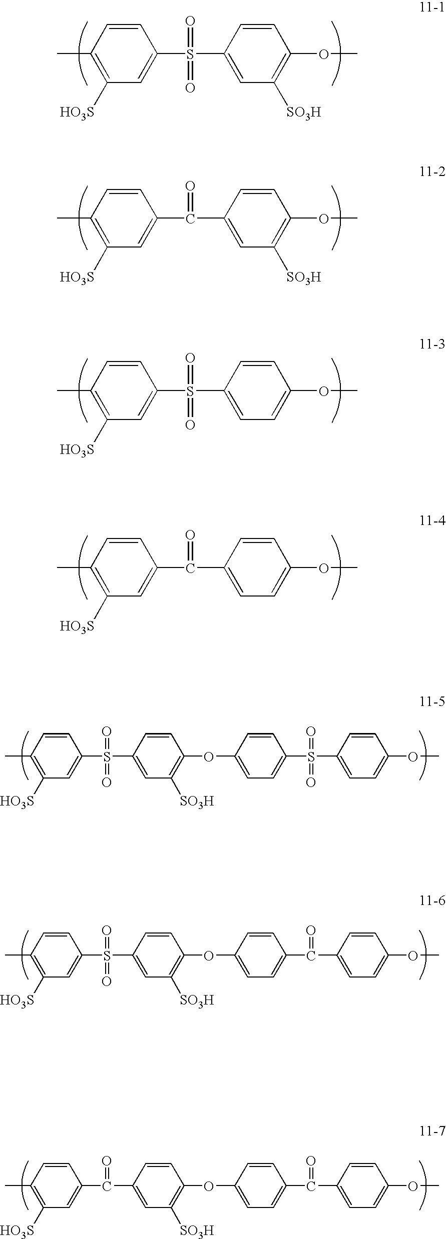

Also, as the structural unit expressed by the above general formula (8b) with a sulfonic acid group, for example, structural units expressed by the following formulas 12-1 through 12-15 can be exemplified.

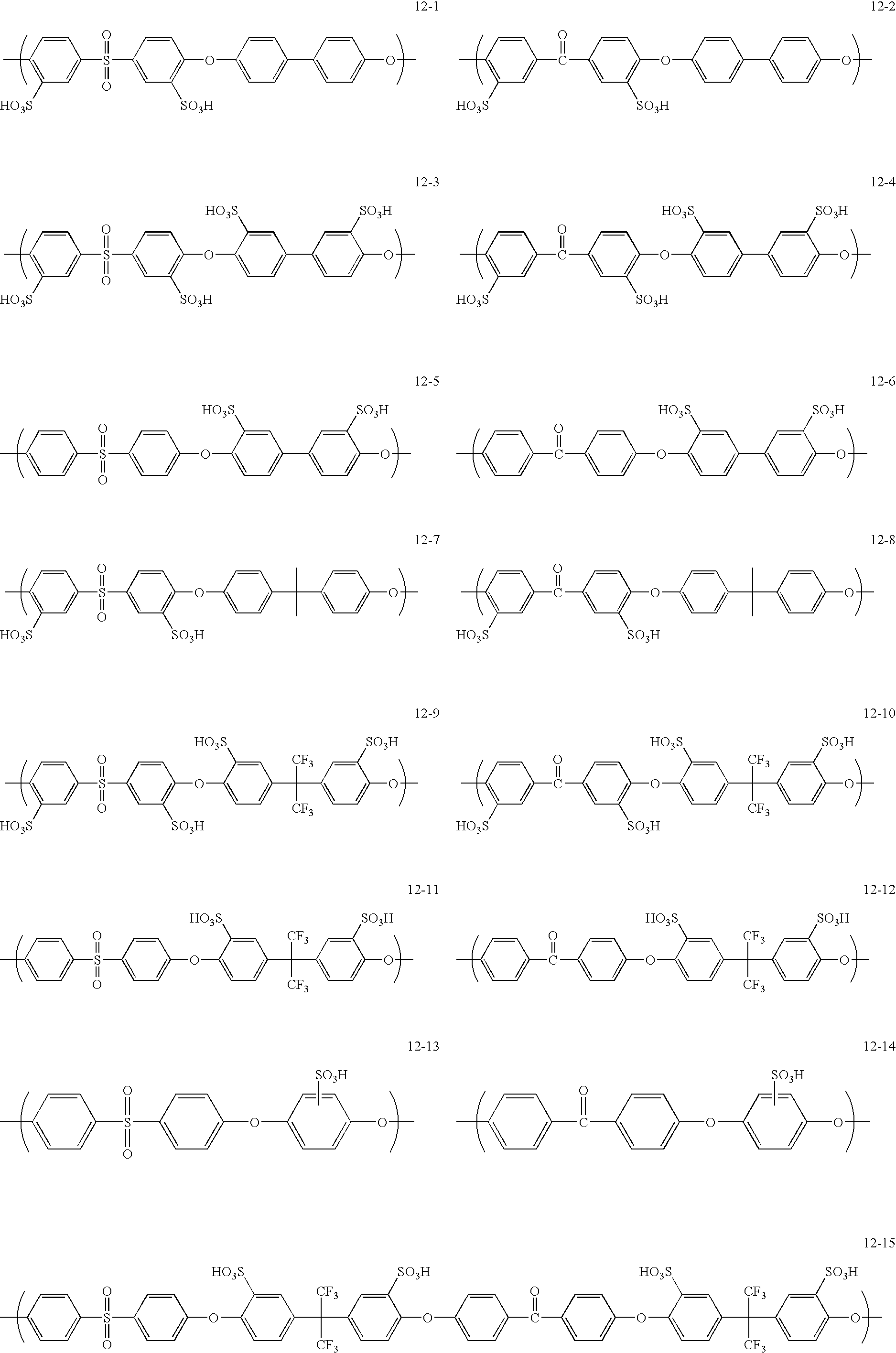

Of the above descriptions, a polymer electrolyte having a structural unit expressed by the following formula (9) is preferable, such structure includes the structures expressed by the 12-1 to 12-4, described above: 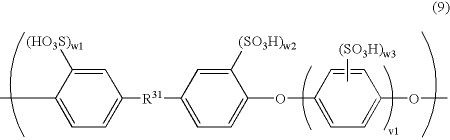
wherein R³¹ represents a carbonyl group or a sulfonyl group, w1 and w2 each independently are 0 or 1, at least either one is 1, w3 is 0, 1 or 2, and v1 is 1 or 2.

Also, as the structure expressed by the above formula (8c) with a sulfonic acid group, for example, structural units expressed by the following formulas 13-1 through 13-6 can be exemplified.

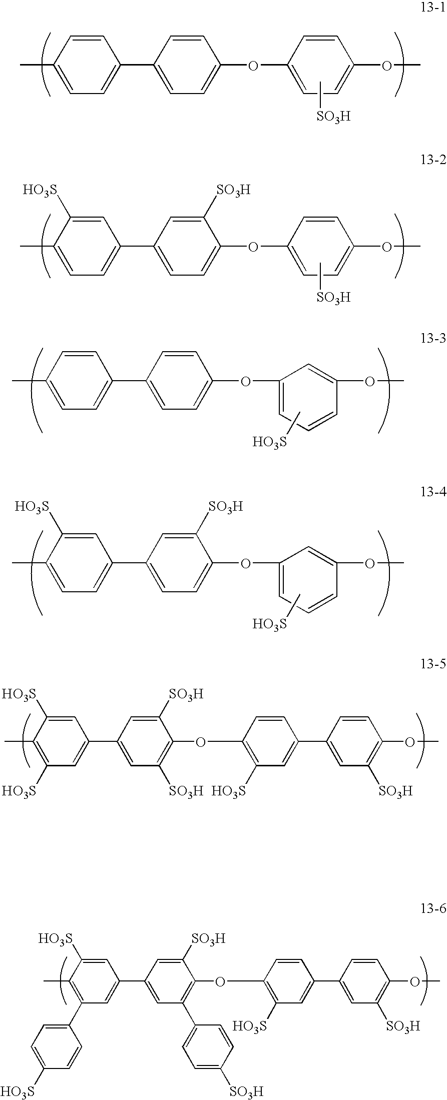

Further, a preferable polymer electrolyte as the component (a) of the present invention may include a structural unit having an alkylene group that may be substituted or a fluoroalkylene group that may be substituted in addition to the structural unit shown in the foregoing formula (8) with a sulfonic acid group, specifically, the following structural units are listed.

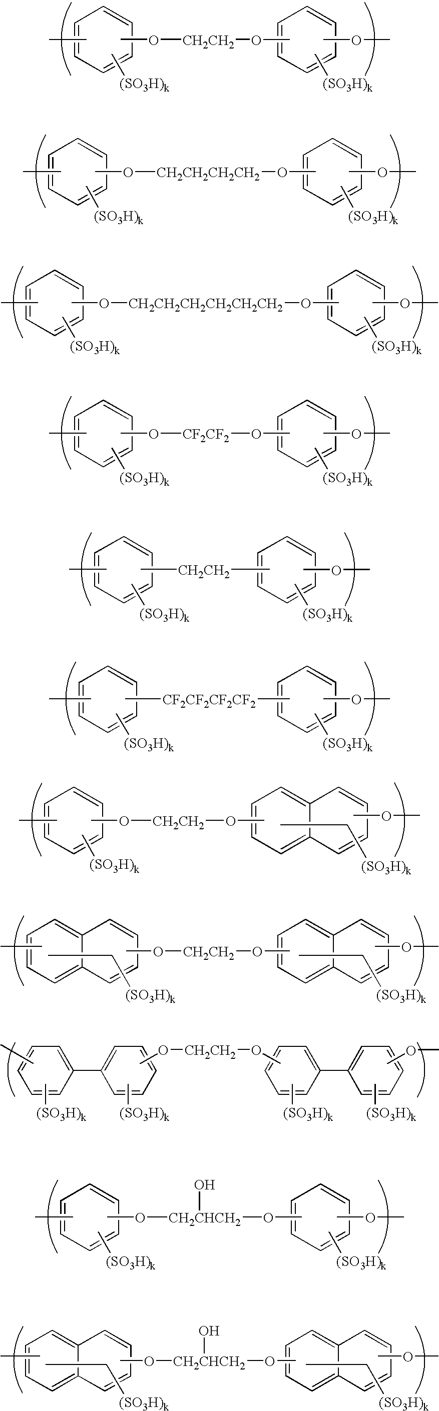

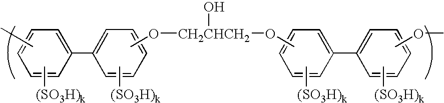

The polymer electrolyte as the component (a) of the present invention may be a polymer compound composed of the structural unit having a sulfonic acid group as a strong acid group, or a copolymer composed of the structural units as described in the above (E), and further may contain a structural unit having no ion-exchange group contributed to proton conduction.

The structural unit having no such ion-exchange group is also preferably a structural unit containing an aromatic ring, more specifically, a structural unit expressed by the following formula (14) is listed: 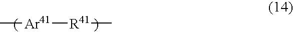
wherein Ar⁴¹ represents a divalent aromatic group that may be substituted with an alkyl group having carbon atoms of 1-10, an alkoxy group having carbon atoms of 1-10, an aryl group having carbon atoms of 6-10 or an aryloxy group having carbon atoms of 6-10, R⁴¹ represents a direct bond, an oxy group, a sulfide group, a carbonyl group, a sulfinyl group or a sulfonyl group.

Of the structural units having no ion-exchange group, a structural unit expressed by the following formula (15) is preferable: 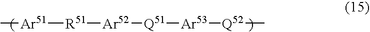
wherein Ar⁵¹, Ar⁵² and Ar⁵³ each independently represent a divalent aromatic group that may be substituted with an alkyl group having carbon atoms of 1-10, an alkoxy group having carbon atoms of 1-10, an aryl group having carbon atoms of 6-10 or an aryloxy group having carbon atoms of 6-10, Q⁵¹ and Q⁵² each independently represent an oxy group or a sulfide group, R⁵¹ represents a carbonyl group or a sulfonyl group.

In the structural unit expressed by the foregoing general formula (15), as the group expressed by Ar⁵¹-Ar⁵³, the same one as the group expressed in the foregoing Ar¹¹ is listed, in particular, a phenylene group is preferable. Also, Q⁵¹ and Q⁵² are preferably an oxy group (—O—). Additionally, in the structure expressed as the above formula (15), groups expressed as Ar⁵¹-Ar⁵³, Q⁵¹ and Q⁵², or R⁵¹ may different or the same in each structural unit.

Above all, as the above structural unit having no ion-exchange group, a structural unit expressed by the following formula (16) is preferable: 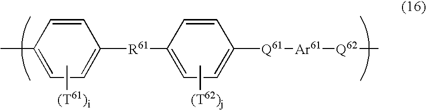
wherein Ar⁶¹ represents a divalent aromatic group that may be substituted with an alkyl group having carbon atoms of 1-10, an alkoxy group having carbon atoms of 1-10, an aryl group having carbon atoms of 6-10 or an aryloxy group having carbon atoms of 6-10. Q⁶¹ and Q⁶² each independently represent an oxy group or a sulfide group, T⁶¹ and T⁶² each independently represent an alkyl group having carbon atoms of 1-10, an alkoxy group having carbon atoms of 1-10, an aryl group having carbon atoms of 6-10 or an aryloxy group having carbon atoms of 6-10, R⁶¹ represents a carbonyl group or a sulfonyl group, i and j are each independently an integer of 0 to 4.

wherein Ar⁶¹, Q⁶¹, Q⁶² and R⁶¹ are each preferably the same groups as the above Ar⁵³, Q⁵¹, Q⁵² and R⁵¹, in particular, Ar⁶¹ is preferably a phenylene group or a biphenylene group, and further, as T⁶¹ or T⁶², functional groups such as the groups which may substitute the foregoing Ar²¹-Ar²⁷ are listed, also, the above i and j are preferably zero in particular.

As the above structure unit having no ion-exchange group, more particularly, for example, structural units expressed by the following formulas 17-1 through 17-18 can be exemplified.

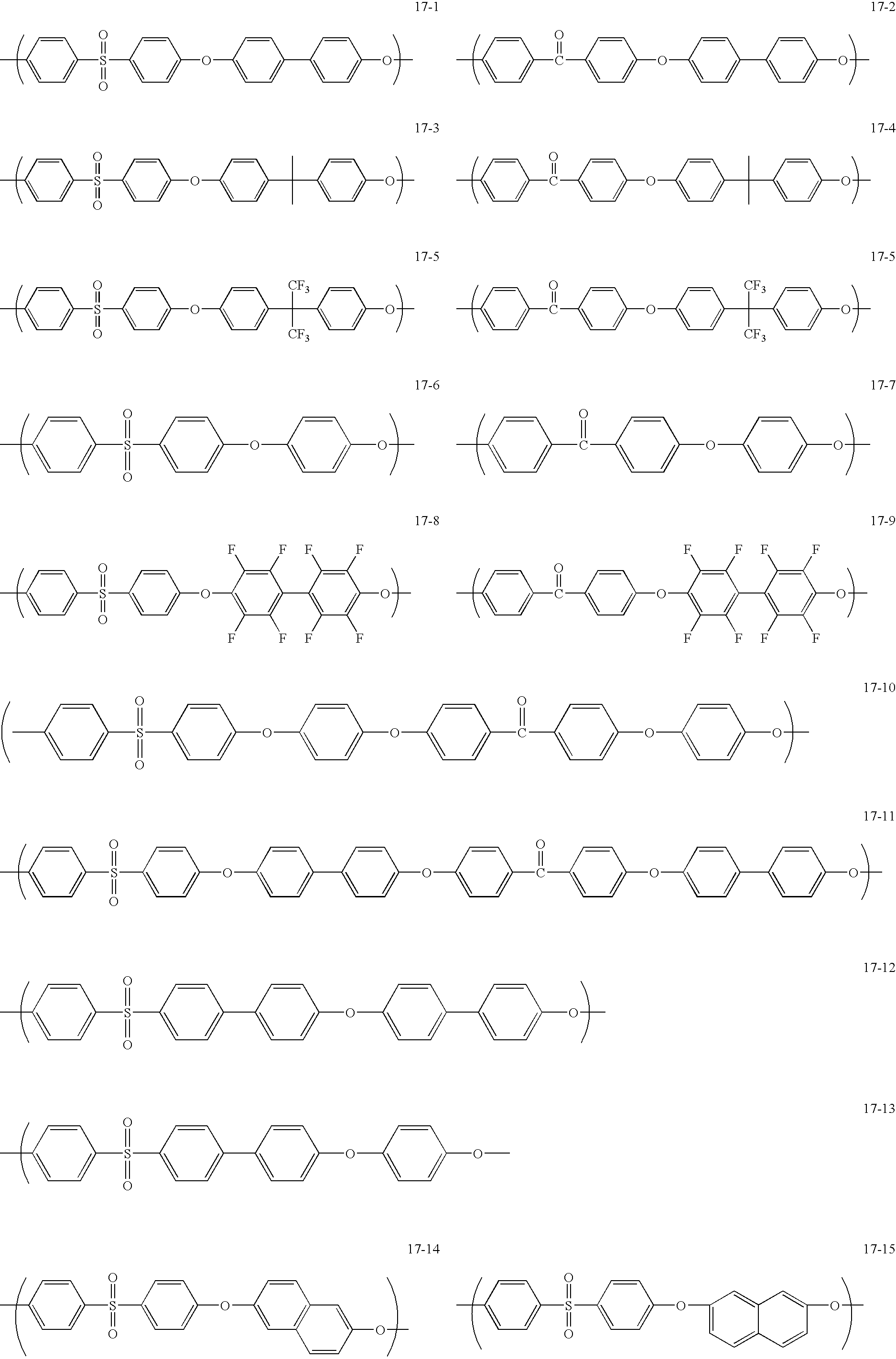

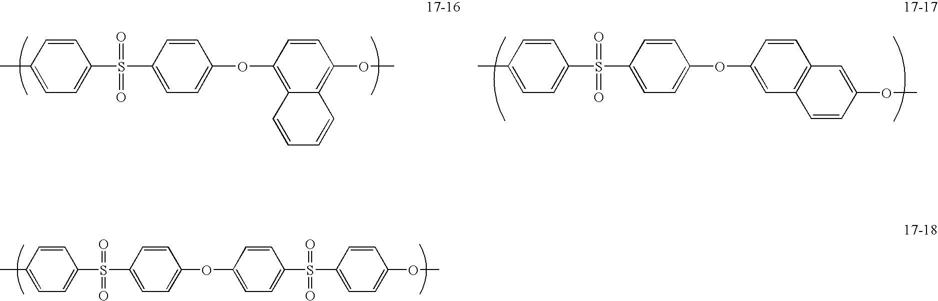

As the above structural unit having no ion-exchange group among them, the structural unit expressed by the foregoing formula (16) is preferable, at least one kind of structural unit expressed by 17-1 to 17-10 and 17-15 to 17-18 is preferable, at least one kind of structural unit expressed by 17-1, 17-3, 17-5 to 17-7 and 17-15 to 17-18 is more preferable, and at least one kind of structural unit expressed by 17-1 and 17-15 to 17-18 is particularly preferable.

Also, in addition to the structural unit expressed by the above (14), the component (a) may include a structural unit having an alkylene group that may be substituted or a fluoroalkylene group that may be substituted, as the above structural unit having no ion-exchange group, and specifically, the following structural units are preferable.

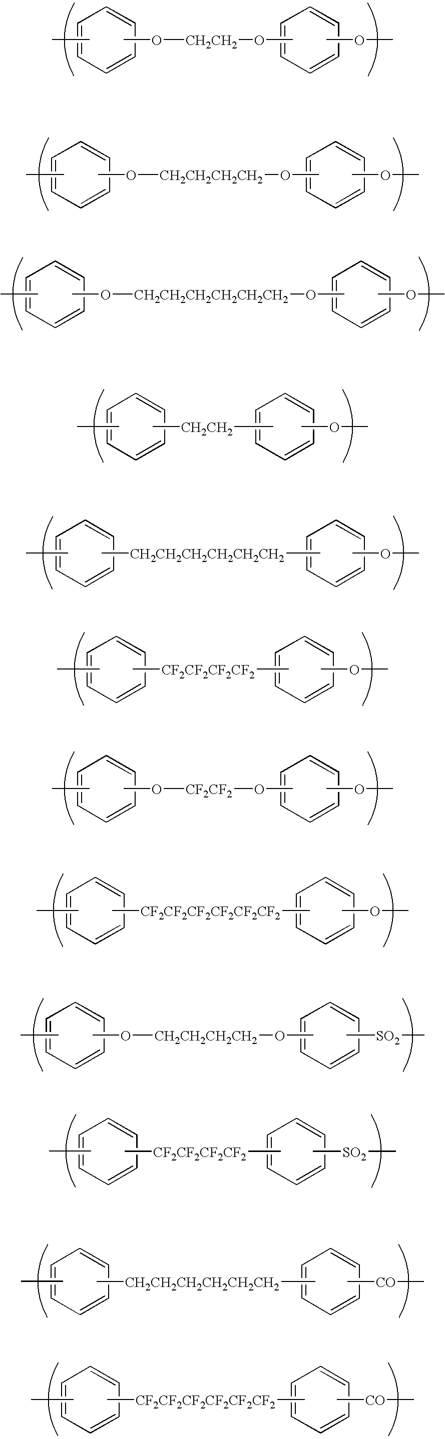

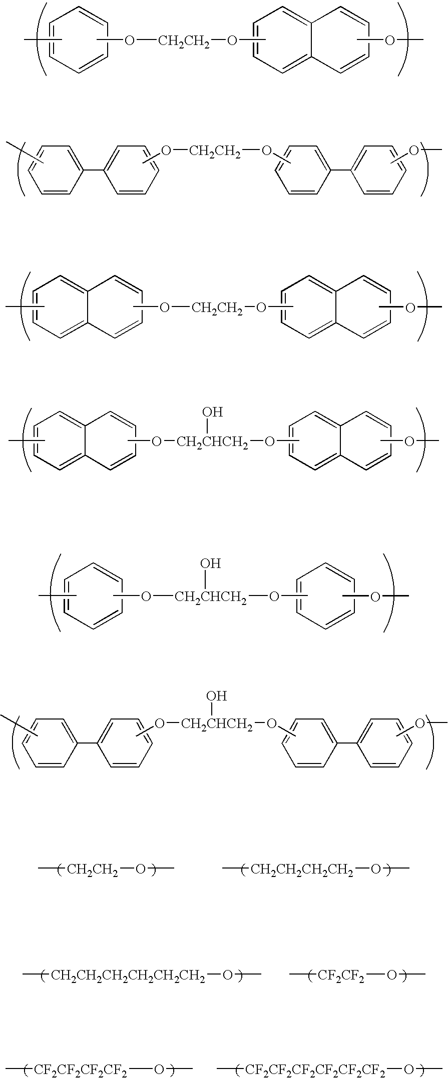

A structural unit having a sulfonic acid group exemplified in the foregoing formula (8) and a structural unit having no ion-exchange group exemplified in the formula (14) may be randomly copolymerized in a polymer chain, or may be a graft copolymer having a branched polymer chain.

As a particularly preferable polymer electrolyte of the component (a), there is listed a block copolymer each having at least one block composed of structural unit exemplified in the foregoing formula (8) with a sulfonic acid group (hereinafter called polymer electrolyte block) and a block composed of structural unit having no ion-exchange group exemplified in the above formula (14) (hereinafter called polymer non-electrolyte block).

As a production method of the block copolymer, for example, there are listed a method (1) that a polymer compound 1 capable of becoming a polymer electrolyte block and a polymer compound 2 capable of becoming a polymer non-electrolyte block are separately produced, followed by coupling the polymer compound 1 with the polymer compound 2; a method (2) that a polymer compound 1 capable of becoming polymer electrolyte block is produced beforehand, and the polymer compound 1 and a monomer capable of becoming a polymer non-electrolyte block are copolymerized; a method (3) that a polymer compound 2 capable of becoming polymer non-electrolyte block is produced beforehand, the polymer compound 2 and a monomer capable of becoming a polymer electrolyte block are copolymerized, and the like.

Here, a block copolymer in the method (1) can be produced by a reaction in combinations of polymer compound 1 having hydroxy or halogeno groups at both ends, or a hydroxy group at one end and a halogeno group at another end with a polymer compound 2 having hydroxy or halogeno groups at both ends, or a hydroxy group at one end and a halogeno group at another end. For example, there are exemplified a method that a polymer compound 1 having hydroxy groups at both ends and a polymer compound 2 having halogeno groups at both ends are condensed in nucleophilic substitution under a base operation; a method that a polymer composition 1 having a hydroxy group and a halogeno group at both ends and a polymer composition 2 having a hydroxy group and a halogeno group at both ends are condensed in nucleophilic substitution under a base operation; a method that a polymer compound 1 having hydroxy groups at both ends and a polymer compound 2 having hydroxy groups at both ends are bonded with a compound acting as a bonding group such as 4,4′-difluorobenzophenone, decafluorobiphenyl, hexafluorobenzene and 4,4′-difluorodiphenylsulfone; a method that a polymer compound 1 having halogeno groups at both ends and another polymer having polymer compounds 2 at both ends are bonded using a compound acting as a bonding group such as 4,4′-dihydroxybiphenyl, bisphenol A, 4,4′-dihydroxybenzophenone and 4,4′-dihydroxydiphenylsulfone, or a method of bonding by dehalogen condensation reaction. Also, the block copolymer can be produced by a method of polymerization reaction of a polymer compound having a reactive group capable of undergoing the same elementary reaction as the above reaction and monomers. Here, the respective polymers can be produced in accordance with known methods.

In the production of block copolymers using a bonding group as described above, in the case where multifunctional bonding groups such as decafluorobiphenyl and hexafluorobenzene are used, a block copolymer with a branched structure can be produced by controlling reaction conditions.

Polymer Electrolyte Composition

The polymer electrolyte composition of the present invention is one that the above component (b) (hereinafter abbreviated as (b)) and the above component (c) (hereinafter abbreviated as (c)) are contained in the above component (a) (hereinafter abbreviated as (a)), and the weight ratio of (b) to (a) is ordinarily chosen from 0.1 to 80.0% by weight. The minimum weight ratio of (b) to (a) is preferably 0.2% by weight or more, further preferably 0.3% by weight or more, notably preferably 0.4% by weight or more, and particularly preferably 0.5% by weight or more. On the other hand, the maximum weight ratio of (b) to (a) is preferably 50.0% by weight or less, further preferably 40.0% by weight or less, notably preferably 30.0% by weight or less, and particularly preferably 20.0% by weight or less. Namely, the weight ratio of (b) to (a) is preferably 0.2 to 50.0% by weight, further preferably 0.3 to 40.0% by weight, notably preferably 0.4 to 30.0% by weight, and particularly preferably 0.5 to 20.0% by weight. When the content of the (b) is too small, it is not preferable because effect of radical resistance in polymer electrolyte composition membrane becomes small, when the content of the (b) is too large, it is not preferable because there are instances that sufficient proton conductivity can not be exhibited in use as a polymer electrolyte membrane for fuel cells.

Moreover, the amount of (c) to (a) is ordinarily chosen from 0.05 to 50.0% by weight. The minimum weight ratio of (c) to (a) is preferably 0.1% by weight or more, further preferably 0.2% by weight or more, and particularly preferably 0.5% by weight or more. On the other hand, the maximum weight ratio of (c) to (a) is preferably 25.0% by weight or less, further preferably 10.0% by weight or less, and particularly preferably 5.0% by weight or less. Namely, the weight ratio of (c) to (a) is preferably 0.1 to 25.0% by weight, further preferably 0.2 to 10.0% by weight, and particularly preferably 0.5 to 5.0% by weight. When the content of (c) is too small, it is not preferable because effect of radical resistance in polymer electrolyte composition membrane becomes small, when the content of antioxidant is too large, it is not preferable because there are instances that sufficient proton conductivity cannot be exhibited in use as a polymer electrolyte membrane for fuel cells.

Also, in the polymer electrolyte composition of the present invention, the content of (b) is preferably larger than the content of (c), which makes radical resistance better. The content of (b) is preferably 1.2 times or more of the content of (c) in weight ratio, further preferably 1.5 times or more, and particularly preferably 2 times or more.

A compounding method of the above (b) and (c) is not particularly limited, for example, there may be a method that the above (b) and (a) are simply mixed with a polymer electrolyte (a), a method that the above (b) and (c) are dissolved in a solution of polymer electrolyte (a) dissolved in a solvent, and a method that the above (b) and (c) are dissolved or dispersed in a solvent beforehand, which is mixed with a solution of polymer electrolyte (a) dissolved in a solvent.

Also, the component (a) and the component (b) may be replaced with the component (d): a polymer electrolyte having at least one group containing a pentavalent phosphorous atom and a strong acid group.

As the component (d), for example, there are listed:

(d-1) a polymer electrolyte having a group shown in the foregoing formula (2) or (3) in part of polymer electrolyte composed of the structure unit shown in the foregoing formula (8) with a sulfonic acid group;

(d-2) a polymer electrolyte having a group shown in the foregoing formula (2) or (3) in part of block copolymer of a polymer electrolyte block composed of the structure unit shown in the foregoing formula (8) with a sulfonic acid group and a polymer non-electrolyte block shown in the foregoing formula (14); and

(d-3) a polymer electrolyte having a structure unit shown in the following formula (17): 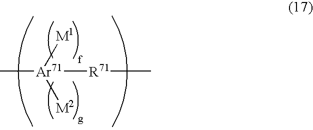
wherein Ar⁷¹ represents a divalent aromatic group that may have an alkyl group having carbon atoms of 1-10, an alkoxy group having carbon atoms of 1-10, an aryl group having carbon atoms of 6-10 or an aryloxy group having carbon atoms of 6-10, M¹ represents the group shown in the foregoing formula (2) or formula (3), M² represents a sulfonic acid group, sulfonic amide group, surfuric group, fluoroalkylsulfonic acid group or the group shown in the foregoing formula (7), f and g each independently represent an integer of 1 to 3, f+g is an integer of 2 to 4, R⁷¹ represents a direct bond, an oxy group, a sulfide group, a carbonyl group, a sulfinyl group and a sulfonyl group.

As Ar⁷¹ in the above formula (17), there are listed a divalent monocyclic aromatic hydrocarbon group such as 1,3-phenylene and 1,4-phenylene; a divalent condensation type aromatic hydrocarbon group such as 1,3-naphthalenediyl, 1,4-naphthalenediyl, 1,5-naphthalenediyl, 1,6-naphthalenediyl, 1,7-naphthalenediyl, 2,6-naphthalenediyl and 2,7-naphthalenediyl; a divalent polycyclic aromatic hydrocarbon group such as 3,3′-biphenylene, 3,4′-biphenylene, 4,4′-biphenylene, diphenylmethane-4′,4′-diyl, 2,2-diphenylpropane-4′,4″-diyl and 1,1,1,3,3,3-hexafluoro-2,2-diphenylpropane-4′,4″-diyl; and a heterocyclic aromatic hydrocarbon group such as pyridinediyl, quinoxalinediyl and thiophenediyl. Among them, a divalent aromatic hydrocarbon group is preferable. Also, an alkyl group having carbon atoms of 1-10, an alkoxy group having carbon atoms of 1-10, an aryl group having carbon atoms of 6-10 or an aryloxy group having carbon atoms of 6-10 is the same group as the group exemplified in Ar¹¹.

Also, the above component (d) may be mixed with the above (a), (b) and (c).

Polymer Electrolyte Membrane

In adopting the polymer electrolyte composition of the present invention to fuel cells, it is preferable to prepare a membrane shape. The method of converting the polymer electrolyte composition of the present invention into a polymer electrolyte membrane is not particularly limited, but a method for forming membrane from solution (solution casting method) is preferable. Namely, it is preferable to use a polymer electrolyte solution wherein the polymer electrolyte is dissolved in a solvent.

Specifically, the above (a), (b) and (c) are dissolved in a suitable solvent, the solution is flow cast on a glass plate, and a polymer electrolyte membrane is prepared by eliminating the solvent. A solvent for forming membrane is not particularly limited as long as it can solve the above polymer electrolyte (a) and also can solve or disperse the above (b) and (c), and thereafter it can be removed, and it can prepare a solution of the polymer electrolyte. Herein, examples of the preferable solvent to be used include a non-proton polar solvent such as N,N-dimethylformamide, N,N-dimethylacetoamide, N-methyl-2-pyrrolidone and dimethylsulfoxide; chlorinated solvent such as dichloromethane, chloroform, 1,2-dichloroethane, chlorobenzene and dichlorobenzene, alcohols such as methanol, ethanol and propanol; and alkyleneglycol monoalkyl ether such as ethyleneglycol monomethyl ether, ethyleneglycol monoethyl ether, propyleneglycol monomethyl ether and propyleneglycol monoethyl ether. These may be used alone, or may be used in mixture of 2 or more kinds of solvents as necessary. Among them, dimethylformamide, dimethylacetoamide, N-methylpyrrolidone and dimethylsulfoxide are preferred because of high solubility of polymer.

It is also possible to use a composite membrane (polymer electrolyte composite membrane) wherein the polymer electrolyte solution is composited using a porous base material as a support. The support is a mother material to which the polymer electrolyte composition is impregnated in order to further increase mainly the mechanical strength and flexibility of the polymer electrolyte composition, for which a fibril or porous shape is used.

In the case where a polymer electrolyte membrane or polymer electrolyte composite membrane of the present invention is used for fuel cells, though the thickness of membrane is not particularly limited, it is preferably 3 to 200 μm, more preferably 4 to 100 μm, and further preferably 5 to 50 μm. When the membrane thickness is too thin, the membrane strength tends to be lowered, whereas when the membrane thickness is too thick, electric resistance becomes high, which is not preferable for a separating membrane in a polymer electrolyte type fuel cell. The membrane thickness can be controlled by choosing the concentration of polymer electrolyte composition solution, or the amount of application of polymer electrolyte composition solution, the thickness of porous support film and thickness of application to the porous support film.

Fuel Cell

Next, the fuel cell of the present invention will be explained.

The fuel cell of the present invention uses the membrane obtained by using the polymer electrolyte composition of the present invention, and it can be produced by conjugating catalyst and conductive material as collector on both sides of the above membrane.

The catalyst is not particularly limited as long as oxidation and reduction reaction with hydrogen or oxygen can be activated, and conventional catalysts can be employed. However, it is preferable to use platinum fine particles. Platinum fine particles are preferably used by being carried on particulate or fibrous carbon of activated carbon or graphite.

Regarding the conductive material as the collector, conventional materials can also be employed, and a porous carbon fabric or carbon paper is preferable to transport source gas into catalyst effectively.

In regard to the methods that platinum fine particles or carbon on which platinum fine particles are carried are conjugated with a porous carbon fabric or carbon paper and which is conjugated with a polymer electrolyte composition film, for example, there can be used a known method described in J. Electrochem. Soc.: Electrochemical Science and Technology, 1988, 135(9), p. 2209.

### EXAMPLES

The present invention will be explained below with reference to Examples, but the present invention is not limited to these examples.

Evaluation of Radical Resistance

The evaluation of radical resistance was conducted in such a manner that a polymer membrane was immersed in an aqueous solution containing 3% hydrogen peroxide and iron chloride of 4 ppm or 20 ppm as a concentration of iron ion at 60° C. or 80° C., and weight change of membrane was measured after 2 hours. Weight retention ratio (%) is expressed as the weight of membrane after 2 hours divided by the weight before immersion in 100(%).

Measurement of Ion Exchange Capacity

It was measured by titration of residual sodium hydroxide using 0.1N aqueous hydrochloric acid after a polymer membrane was immersed in 0.1N aqueous sodium hydroxide solution.

Measurement of Proton Conductivity (Sheet Conductivity)

A polymer membrane was measured by an alternate current method under the conditions of temperature at 80° C. and relative humidity of 90%.

Antioxidant

Abbreviations described in Tables 1 to 5 show the following commercial products.

BHT: Sumilizer BHT manufactured by Sumitomo Chemical Co. Ltd., 2,6-di-butyl-4-methyl phenol

C1790; Cyanox 1790 manufactured by Cytec Industries Inc., 1,3,5-(4-t-butyl-3-hydroxy-2,6-dimethylbenzyl)isocyanuric acid

I1330: Irganox 1330 manufactured by Ciba Specialty Chemicals,

1,3,5-trimethyl-2,4,6-tris(3,5-di-t-butyl-4-hydroxybenzyl)benzene

I1010: Irganox 1010 manufactured by Ciba Specialty Chemicals, pentaerythrityl-tetrakis[3-(3,5-di-t-butyl-4-hydroxyphenyl)propionate]

PEP36: Adekastab PEP-36 manufactured by Asahidenka Co. Ltd. bis(2,6-di-t-butyl-4-methylphenyl)pentaerythritol diphosphite

TSP: Sumilizer TSP manufactured by Sumitomo Chemical Co. Ltd., distearyl-3,3′-thiodipropionate

### Production Example 1-1 [Production of Polymer Electrolyte]

In accordance with the method described in Example 2 in Japanese Unexamined Patent Publication No. 2005-139432, a block copolymer was produced from a block having no acid group derived from 2,6-dihydroxynaphthalene and 4,4′-difluorodiphenylsulfone with a block having a sulfonnic acid group derived from potassium hydroquinone sulfonate and dipotassium 4,4′-difluorodiphenylsulfone-3,3′-disulfonate.

The ion exchange capacity of the polymer was 1.85 meq/g, the proton conductivity was 8.97×10⁻² S/cm. This polymer electrolyte is abbreviated as E1 below.

### Production Example 1-2 [Production of Polymer Electrolyte]

In accordance with the method described in Example 1 in WO2006-095919, The following polyarylene-based block copolymer was prepared by reacting sodium 2,4-dichlorobenzenesulfonate and chloro-group-ended polyethersulfone (Sumika Excel PES5200P manufactured by Sumitomo Chemical Co. Ltd.) using bis(1,5-cyclooctadiene)Nickel(0) under the presence of 2,2′-bipyridyl.

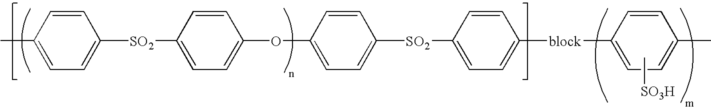

The ion exchange capacity of the polymer was 2.2 meq/g. This polymer electrolyte is abbreviated as E2 below.

### Production Example 1-3 [Production of Polymer Electrolyte]

In accordance with the method described in Example 5 in Japanese Unexamined Patent Publication No. 2005-126684, a hydrophilic oligomer solution was prepared by reacting potassium hydroquinone sulfonate and dipotassium 4,4′-difluorodiphenyl-3,3′-disulfonate. Also a hydrophobic polymer solution was prepared by reacting 4,4′-dihydroxydiphenylsulfone and 4,4′-difluorodiphenylsulfone. Next, the following block copolymer was prepared by mixing and reacting the above hydrophilic oligomer solution and the above hydrophobic polymer solution.

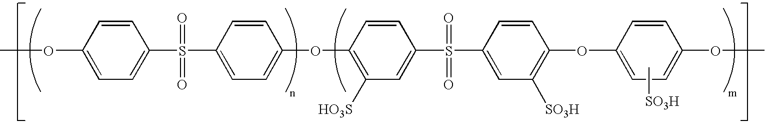

The ion exchange capacity of the polymer was 1.6 meq/g. This polymer electrolyte is abbreviated as E3 below.

### Production Example 2-1 [Production of Polymer Compound Having Phosphonic Acid Group]

In accordance with the method described in Japanese Unexamined Patent Publication No. Hei 10-021943 (1998), the following random copolymer was prepared by reacting 4,4′-dihydroxydiphenylsulfone, 4,4′-dihydroxybiphenyl and 4,4′-dichlorodiphenylsulfone in a molar ratio of 7:3:10 in diphenylsulfone as a solvent under the presence of potassium carbonate.

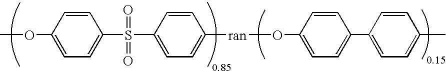

Next, in accordance with the method described in Japanese Unexamined Patent Publication No. 2003-282096, by bromination, phosphonic esterification and hydrolysis of phosphonic ester, a polymer having the following phosphonic group being substituted with about 0.1 of Br and about 1.2 of phosphonic acid group per one unit derived from 4,4′-biphenol was obtained.

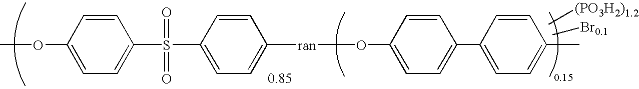

The thus obtained polymer compound is named P1.

### Production Example 2-2 [Production of Polymer Compound Having Phosphonic Acid Group]

The following random copolymer was prepared by reacting 4,4′-dihydroxydiphenylsulfone, 4,4′-dihydroxybiphenyl and 4,4′-dichlorodiphenylsulfone in a mole ratio of 4:6:10 in N-methylpyrolidone as a solvent under the presence of potassium carbonate as a base.

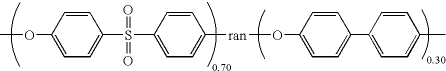

Next, in accordance with the method described in Japanese Unexamined Patent Publication No. 2003-282096, by bromination, phosphonic esterification and hydrolysis of phosphonic ester, a polymer having the following phosphonic group being substituted with about 0.05 of Br and about 1.7 of phosphonic acid group per one unit derived from 4,4′-biphenol was obtained.

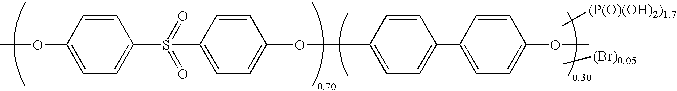

The thus obtained polymer compound is named P2.

### Example 1

The polymer electrolyte E1 obtained in Production Example 1-1 was dissolved in dimethylsulfoxide to prepare a solution for E1 concentration to be 13% by weight. Further, P1 obtained in Production Example 2-1 and Sumilizer BHT were added thereto for the ratio of P1 to E1 to be 11% by weight, for the ratio of Sumilizer BHT to E1 to be 5% by weight, followed by dissolving thereby to prepare a coating solution. The coating solution obtained was applied and spread on a glass plate, solvent was dried thereby to give a polymer electrolyte membrane. The thus obtained polymer electrolyte membrane was evaluated for radical resistance, wherein the above concentration of iron ion is 4 ppm and the above temperature of solution is 60° C. The results are shown in Table 1. Additionally, the values of P1 and antioxidant described in Table 1 show weight ratio (% by weight) in a polymer electrolyte composition relative to polymer electrolyte E1.

### Example 2

The evaluation of radical resistance was conducted in the same manner as in Example 1 except that Sumilizer BHT was changed to Cyanox 1790. Wherein the above concentration of iron ion is 4 ppm and the above temperature of solution is 60° C. The results are shown in Table 1.

### Comparative Example 1

The polymer electrolyte membrane obtained from only the above component (a) was evaluated for radical resistance by the same test.

Namely, the polymer electrolyte E1 was dissolved in dimethylsulfoxide to prepare a coating solution for E1 concentration to be 13% by weight. This solution was applied and spread on a glass plate, solvent was dried thereby to give a polymer electrolyte membrane. The thus obtained polymer electrolyte membrane was evaluated for radical resistance, wherein the above concentration of iron ion is 4 ppm and the above temperature of solution is 60° C. The results are shown in Table 1.

### Comparative Example 2

The polymer electrolyte membrane obtained from a polymer electrolyte composition containing only the above component (a) and the above component (b) was evaluated for radical resistance by the same test.

Namely, the polymer electrolyte E1 was dissolved in dimethylsulfoxide to prepare a solution for E1 concentration to be 13% by weight. Further, P1 obtained in Production Example 2-1 was added thereto for the ratio of P1 to E1 to be 11% by weight, thereby to prepare a coating solution. This coating solution was applied and spread on a glass plate, solvent was dried thereby to give a polymer electrolyte membrane. The thus obtained polymer electrolyte membrane was evaluated for radical resistance, wherein the above concentration of iron ion is 4 ppm and the above temperature of solution is 60° C. The results are shown in Table 1.

TABLE 1
component (a): E1
Concentration of iron: 4 ppm
Temperature of solution: 60° C.

| | | | | | Comparative | Comparative |
|---|---|---|---|---|---|---|
| | | | Example 1 | Example 2 | Example 1 | Example 2 |
| Polymer | Component | P1 | 11 | 11 | | 11 |
| electrolyte | (b) | | | | | |
| composition | Component | BHT | 5 | | | |
| | (c) | C1790 | | 5 | | |

| | | | | |
|---|---|---|---|---|
| Membrane thickness [μm] | 48 | 40 | 37 | 43 |
| Weight retention rate | 91% | 93% | 51% | 83% |

The values of P1 and antioxidants described in Table 1 show weight ratio (% by weight) in a polymer electrolyte composition relative to polymer electrolyte E1.

### Comparative Example 3

The polymer electrolyte membrane obtained from a polymer electrolyte composition containing only the above component (a) and the above component (c) was evaluated for radical resistance by the same test.

Namely, the polymer electrolyte E1 was dissolved in dimethylsulfoxide to prepare a solution for E1 concentration to be 13% by weight. Further, Sumilizer BHT was dissolved in the solution for the ratio of Sumilizer BHT to E1 to be 5% by weight, thereby to prepare a coating solution. This coating solution was applied and spread on a glass plates solvent was dried thereby to give a polymer electrolyte membrane. The thus obtained polymer electrolyte membrane was evaluated for radical resistance, wherein the above concentration of iron ion is 4 ppm and the above temperature of solution is 60° C. The results are shown in Table 2.

### Comparative Examples 4 to 8

The same test was conducted as in Comparative Example 3 except that Sumilizer BHT (5% by weight to E1) described in Comparative Example 3 was changed to the antioxidants shown in Table 2. The results are shown in Table 2.

TABLE 2
component (a): E1
Concentration of iron: 4 ppm
Temperature of solution: 60° C.

| | | | Comparative | Comparative | Comparative | Comparative | Comparative | Comparative |
|---|---|---|---|---|---|---|---|---|
| | | | Example 3 | Example 4 | Example 5 | Example 6 | Example 7 | Example 8 |
| Polymer | Component | P1 | | | | | | |
| electrolyte | (b) | | | | | | | |
| composition | Component | BHT | 5 | | | | | |
| | (c) | C1790 | | 5 | | | | |
| | | I1330 | | | 1 | | | |
| | | I1010 | | | | 1 | | |
| | | PEP36 | | | | | 2 | |
| | | TPS | | | | | | 2 |

| | | | | | | |
|---|---|---|---|---|---|---|
| Membrane thickness [μm] | 41 | 53 | 26 | 29 | 30 | 31 |
| Weight retention rate | 52% | 56% | 43% | 45% | 48% | 53% |

The values of antioxidants described in Table 2 show weight ratios (% by weight) in a polymer electrolyte composition relative to polymer electrolyte E1.

### Comparative Example 9

The polymer electrolyte membrane obtained from a polymer electrolyte composition containing a mixture of only the above component (a) and 2 kinds of the above component (c) was evaluated for radical resistance by the same test.

Namely, the polymer electrolyte E1 was dissolved in dimethylsulfoxide to prepare a solution for E1 concentration to be 13% by weight. Further, Irganox 1330 and PEP36 each were mixed in the solution for their ratios to E1 to be 1% by weight and 2% by weight respectively, thereby to prepare a coating solution. This coating solution was applied and spread on a glass plate, solvent was dried thereby to give a polymer electrolyte membrane. The thus obtained polymer electrolyte membrane was evaluated for radical resistance, wherein the above concentration of iron ion is 4 ppm and the above temperature of solution is 60° C. The results are shown in Table 3.

### Comparative Examples 10 to 12

The same test was conducted as in Comparative example 9 except that the combination of the antioxidants in Comparative Example 9 was changed to the antioxidants and the amounts compounded shown in Table 3. The results are shown in Table 3.

TABLE 3
component (a): E1
Concentration of iron: 4 ppm
Temperature of solution: 60° C.

| | | | Comparative | Comparative | Comparative | Comparative |
|---|---|---|---|---|---|---|
| | | | Example 9 | Example 10 | Example 11 | Example 12 |
| Polymer | Component | P1 | | | | |
| electrolyte | (b) | | | | | |
| composition | Component | BHT | | | | |
| | (c) | C1790 | | | | |
| | | I1330 | 1 | | 1 | |
| | | I1010 | | 1 | | 1 |
| | | PEP36 | 2 | | | 2 |
| | | TPS | | 1 | 1 | |

| | | | | |
|---|---|---|---|---|
| Membrane thickness [μm] | 31 | 40 | 31 | 34 |
| Weight retention rate | 48% | 52% | 51% | 49% |

The values of antioxidants described in Table 3 each show weight ratio (% by weight) in a polymer electrolyte composition relative to polymer electrolyte E1.

### Example 3

The polymer electrolyte E2 obtained in Production Example 1-2 was dissolved in dimethylsulfoxide to prepare a solution for E2 concentration to be 10% by weight. Further, P2 obtained in Production Example 2-2 and Sumilizer BHT were added thereto for the ratio of P2 to E2 to be 11% by weight, for the ratio of Sumilizer BHT to E2 to be 1% by weight, followed by dissolving thereby to prepare a coating solution. The coating solution obtained was applied and spread on a glass plate, solvent was dried thereby to give a polymer electrolyte membrane. The thus obtained polymer electrolyte membrane was evaluated for radical resistance, wherein the above concentration of iron ion is 20 ppm and the above temperature of solution is 80° C. The results are shown in Table 4. Additionally, the values of P2 and antioxidant described in Table 4 show weight ratio (% by weight) in a polymer electrolyte composition relative to polymer electrolyte E2.

### Examples 4 to 6

The evaluation of radical resistance was conducted in the same manner as in Example 3 except that the antioxidant described in Example 3 was changed to the antioxidants and the amounts compounded shown in Table 4. The results are shown in Table 4.

### Comparative Example 13

The polymer electrolyte E2 obtained in Production Example 1-2 was dissolved in dimethylsulfoxide to prepare a coating solution for E2 concentration to be 10% by weight. This solution was applied and spread on a glass plate, solvent was dried thereby to give a polymer electrolyte membrane. The thus obtained polymer electrolyte membrane was evaluated for radical resistance, wherein the above concentration of iron ion is 20 ppm and the above temperature of solution is 80° C., The results are shown in Table 4.

### Comparative Example 14

The polymer electrolyte E2 obtained in Production Example 1-2 was dissolved in dimethylsulfoxide to prepare a solution for E2 concentration to be 10% by weight. Further, P2 obtained in Production Example 2-2 was added thereto for the ratio of P2 to E2 to be 11% by weight, thereby to prepare a coating solution. This coating solution was applied and spread on a glass plate, solvent was dried thereby to give a polymer electrolyte membrane. The thus obtained polymer electrolyte membrane was evaluated for radical resistance, wherein the above concentration of iron ion is 20 ppm and the above temperature of solution is 80° C. The results are shown in Table 4.

TABLE 4
component (a): E2
Concentration of iron: 20 ppm
Temperature of solution: 80° C.

| | | | | | | | Comparative | Comparative |
|---|---|---|---|---|---|---|---|---|
| | | | Example 3 | Example 4 | Example 5 | Example 6 | Example 13 | Example 14 |
| Polymer | Component | P2 | 11 | 11 | 11 | 11 | | 11 |
| electrolyte | (b) | | | | | | | |
| composition | Component | BHT | 1 | 5 | | | | |
| | (c) | C1790 | | | 1 | 5 | | |

| | | | | | | |
|---|---|---|---|---|---|---|
| Membrane thickness [μm] | 41 | 43 | 43 | 44 | 43 | 37 |
| Weight retention rate | 75% | 85% | 73% | 83% | 0% | 44% |

The values of P2 and antioxidants described in Table 4 show weight ratios (% by weight) in a polymer electrolyte composition relative to polymer electrolyte E2.

### Example 7

The polymer electrolyte E3 obtained in Production Example 1-3 was dissolved in 1-methyl-2-pyrrolidone to prepare a solution for E3 concentration to be 30% by weight. Further, P2 obtained in Production Example 2-2 and Sumilizer BHT were added thereto for the ratio of P2 to E3 to be 11% by weight, for the ratio of Sumilizer BHT to E3 to be 1% by weight, followed by dissolving thereby to prepare a coating solution. The coating solution obtained was applied and spread on a glass plate, solvent was dried thereby to give a polymer electrolyte membrane. The thus obtained polymer electrolyte membrane was evaluated for radical resistance, wherein the above concentration of iron ion is 4 ppm and the above temperature of solution is 60° C. The results are shown in Table 5. Additionally, the values of P2 and antioxidant described in Table 5 show weight ratio (% by weight) in a polymer electrolyte composition relative to polymer electrolyte E3.

### Examples 8 to 10

The evaluation of radical resistance was conducted in the same manner as in Example 7 except that the antioxidant described in Example 7 was changed to the antioxidants and the amounts compounded shown in Table 5. The results are shown in Table 5.

### Comparative Example 15

The polymer electrolyte E3 obtained in Production Example 1-3 was dissolved in 1-methyl-2-pyrrolidone to prepare a coating solution for E2 concentration to be 30% by weight. This solution was applied and spread on a glass plate, solvent was dried thereby to give a polymer electrolyte membrane. The thus obtained polymer electrolyte membrane was evaluated for radical resistance, wherein the above concentration of iron ion is 4 ppm and the above temperature of solution is 60° C. The results are shown in Table 5.

### Comparative Example 16

The polymer electrolyte E3 obtained in Production Example 1-3 was dissolved in 1-methyl-2-pyrrolidone to prepare a solution for E3 concentration to be 30% by weight. Further, P2 obtained in Production Example 2-2 was added thereto for the ratio of P2 to E3 to be 11% by weight, thereby to prepare a coating solution. This coating solution was applied and spread on a glass plate, solvent was dried thereby to give a polymer electrolyte membrane. The thus obtained polymer electrolyte membrane was evaluated for radical resistance, wherein the above concentration of iron ion is 4 ppm and the above temperature of solution is 60° C. The results are shown in Table 5.

TABLE 5
component (a): E2
Concentration of iron: 4 ppm
Temperature of solution: 60° C.

| | | | | | | | Comparative | Comparative |
|---|---|---|---|---|---|---|---|---|
| | | | Example 7 | Example 8 | Example 9 | Example 10 | Example 15 | Example 16 |
| Polymer | Component | P2 | 11 | 11 | 11 | 11 | | 11 |
| electrolyte | (b) | | | | | | | |
| composition | Component | BHT | 1 | 5 | | | | |
| | (c) | C1790 | | | 1 | 5 | | |

| | | | | | | |
|---|---|---|---|---|---|---|
| Membrane thickness [μm] | 76 | 34 | 37 | 45 | 45 | 46 |
| Weight retention rate | 100% | 99% | 98% | 98% | 60% | 85% |

The values of P2 and antioxidants described in Table 5 show weight ratios (% by weight) in a polymer electrolyte composition relative to polymer electrolyte E3.

It has become clear from the results obtained in Examples 1-10 and Comparative Examples 1-16 that since the polymer electrolyte composition of the present invention contains both a specific polymer having a phosphonic acid group and an antioxidant, the polymer electrolyte membrane obtained has excellent radical resistance compared with one containing only a specific polymer having a phophonic acid group or only antioxidants. Accordingly, a polymer electrolyte type fuel cell with excellent durability can be obtained by using the polymer electrolyte membrane of the present invention as a polymer electrolyte membrane for fuel cell.

What is claimed is:

1. A polymer electrolyte composition comprising the following component (a), (b) and (c):
(a) a polymer electrolyte having a strong acid group,
(b) a compound having at least one group containing a pentavalent phosphorous atom, and
(c) an antioxidant.

2. The polymer electrolyte composition of claim 1, wherein the weight ratio of the component (b) to the component (a) is 0.1 to 80.0% by weight.

3. The polymer electrolyte composition of claim 1, wherein the weight ratio of the component (c) to the component (a) is 0.05 to 50.0% by weight.

4. The polymer electrolyte composition of claim 1, wherein the content of the component (b) is larger than the content of the component (c).

5. The polymer electrolyte composition of claim 1, wherein the component (b) comprises a compound shown in the following formula (1a) or a compound having a group shown in the formula (1b): 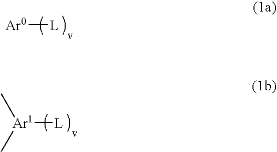
wherein Ar⁰ and Ar¹ represent an aromatic group, L represents a group shown in the following formula (2) or (3), v is an integer of 1 to 4, L may be different from each other when v is 2 or more, and L directly bonds to an aromatic ring of Ar⁰ or Ar¹: 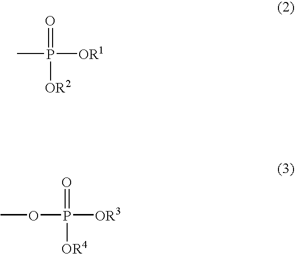
wherein R¹, R², R³ and R⁴ each independently represent a hydrogen atom or a monovalent organic group.

6. The polymer electrolyte composition of claim 5, wherein the component (b) comprises a compound having a group shown in the foregoing formula (2).

7. The polymer electrolyte composition of claim 5, wherein the component (b) comprises a polymer compound having a group shown in the foregoing formula (2) and/or a group shown in the foregoing formula (3).

8. The polymer electrolyte composition of claim 7, wherein the polymer compound comprises a polymer compound having a structural unit expressed by the following formula (4): 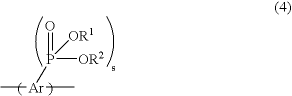
wherein Ar represents an aromatic group having carbon atoms of 4-18, the aromatic group may have a substituent group, s is an average number per one of the structural unit of the group expressed by the foregoing formula (2) being bonded to Ar, and represents a positive number of 8 or less, R¹ and R² are the same definitions as described above.

9. The polymer electrolyte composition of claim 7, wherein the polymer compound comprises a polymer compound having a structural unit expressed by the following formula (5): 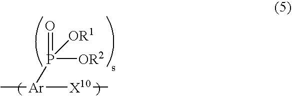
wherein X¹⁰ represents a direct bond, an oxygen atom or a sulfur atom, Ar, s, R¹ and R² are the same definitions as described above.

10. The polymer electrolyte composition of claim 7, wherein the polymer compound comprises a copolymer expressed by the following formula (6): 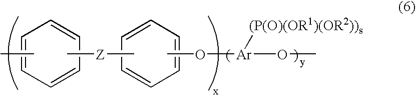
wherein Z represents a sulfonyl group or a carbonyl group, x and y are molar ratios of each structural unit in the copolymer, each representing 0.01 to 0.99, the sum of x and y is 1, Ar, s, R¹ and R² are the same definitions as described above.

11. The polymer electrolyte composition of claim 1, wherein the component (c) is a hindered phenol type compound.

12. The polymer electrolyte composition of claim 1, wherein the component (a) is a block copolymer comprising a block having a strong acid group and a block substantially having no acid group.

13. A polymer electrolyte composition comprising the following component (d) and (c):
(d) a polymer electrolyte having at least one group containing a pentavalent phosphorous atom and a strong acid group, and
(c) an antioxidant.

14. A polymer electrolyte membrane obtained using the polymer electrolyte composition of any one of claims 1 to 13.

15. A polymer electrolyte type fuel cell obtained using the polymer electrolyte membrane of claim 14.
